(19) United States
(12) Patent Application Publication
(10) Pub. No.: US 2008/0031627 A1
(43) Pub. Date: Feb. 7, 2008

(54) OPTICAL COMMUNICATION SYSTEM

(76) Inventors: Irl W. Smith, Concord, MA (US); William J. Miniscalco, Sudbury, MA (US); Terry A. Dorschner, Marlborough, MA (US)

Correspondence Address: RAYTHEON COMPANY;c/o DALY, CROWLEY, MOFFORD & DURKEE, LLP, 354A TURNPIKE STREET, SUITE 301A, CANTON, MA, 02021-2714, US

(21) Appl. No.: 11/462,569

(22) Filed: Aug. 4, 2006

(51) Int. Cl. H04J 14/02

(52) U.S. Cl. 398/83

(57) ABSTRACT

An optical communication system having nodes that include add/drop units. The add/drop unit includes: a network input port for receiving optical energy having a plurality of different wavelengths from other nodes in the network; a network output port for coupling to destination nodes in the network; an add port for receiving optical energy having the plurality of different wavelengths from a local source for transmission to other nodes in the network; and a drop node for receiving optical energy from other nodes in the network for local processing. A wavelength demultiplexer is included to separate the plurality of wavelengths received by the network input port so that the electronically controllable beam steerer can process them individually. A wavelength multiplexer is included to combine the plurality of wavelengths received from the electronically controlled beam steerer for delivery to the network output port for transmission to other nodes in the network. An electronically controllable beam steerer is provided for receiving the optical energy having the plurality of different wavelengths at the network input port and the optical energy having the plurality of different wavelengths from the add port for selectively: directing the optical energy having the plurality of different wavelengths at the network input port to the network output port or to the drop port; and directing the optical energy having the plurality of different wavelengths from the add port to the network output port. The disclosed add/drop unit supports one or a plurality of add, input, output, and drop ports.

### TECHNICAL FIELD

This invention relates generally to optical communication systems and more particularly to optical add/drop multiplexers (OADMs) used in such systems.

### BACKGROUND

As is known in the art, optical communication systems are becoming widely used. In such systems information is modulated onto optical energy, such energy being carried from node to node of the communication system by optical or fiber optic cables. Such a communications system is comprised of a network of nodes. Information is inserted and removed from the network at the nodes and transported between the nodes using optical fiber. Accordingly, network nodes have two general types of ports to support the two general functions they provide: access (add and drop) ports for inserting or removing information from the system, and transport ports for sending and receiving information in the system to/from neighboring nodes.

As is also known in the art, Dense Wavelength Division Multiplexed (DWDM) telecommunication optical systems carry a large number (typically 10-100) of independent optical channels in a single fiber. Each optical channel is transported by an optical wave at a specific wavelength. The wavelengths to be used are specified by the International Telecommunications Union—Telecommunications Standardization Sector (ITU-T). In a DWDM network, fiber connects many nodes, at each of which only a fraction (20-30%) of the optical channels in an individual fiber need to be dropped, added, or replaced. Dropping an optical channel at a node requires removing it from the transmission fiber carrying information from adjacent nodes for processing at the local node. Adding an optical channel requires inserting a new channel generated at the local node into the transmission fiber carrying information to adjacent nodes. Because only certain wavelengths can be used, both add and drop operations may be performed on the same wavelength: “replacing” a channel consists of dropping a received channel and adding a new channel at the same wavelength for transmission to an adjacent node.

As is also known in the art, the nodes in an optical communications system frequently include add/drop multiplexers (ADMs). An ADM at a node is adapted to perform the add, drop, and replace functions described above. One possible approach to performing these functions is to terminate all incoming channels to a node by converting each from the optical domain to the electrical domain and then converting each outgoing channel from the electrical to the optical domain. Implementing ADM by terminating all channels is very expensive since it requires sets of costly, high-bandwidth equipment for each channel, even those that are intended for a distant node and do not need electronic processing at the local node.

As is known in the art, optical add/drop multiplexers (OADMs) can save considerable expense by allowing some of the channels to be dropped, added, or replaced while others intended for distant nodes are “expressed” through the local node without electronic conversion. The express channels remain in the optical domain and require no processing in the electronic domain. OADMs add and drop channels to/from the transport system through add and drop ports (also referred to as client interfaces) connected to optical fibers for connection within the local node. There is a need for a practical, flexible, dynamic OADM that has low cost, does not require expensive manual intervention to reconfigure the channels to be added, dropped, or expressed, and can connect any optical channel to any fiber under remote electronic control. In addition, it is desirable that such an OADM provide integrated optical performance monitoring (OPM). In-service OPM reveals the health of the various optical channels without disrupting service and is an important enabler of service quality guarantees. It is also desirable that such an OADM facilitate integrated multicasting (sending a single optical channel in many output directions) and facilitate optical protection switching for enhanced system reliability.

As is also known in the art, several types of optical add/drop multiplexers (OADMs) are in use. One such OADM is a fixed OADM. Fixed OADMs are currently in use and have a low first-cost. Their inflexibility, however, requires expensive manual intervention to configure the channels so that the desired ones will be added, dropped, or expressed through the node. Reconfigurable OADMs (ROADMs) have become available more recently. They eliminate some manual activity because they can be reconfigured electronically from a remote location. However, a particular wavelength can only be input or output on a specific optical fiber. The one-to-one relationship between optical channel and the wavelength used by that channel necessitates an add and drop port at each node for each channel in the system, as well as the prepositioning of expensive spare add/drop transceivers to take advantage of the remote configurability. With optical channel counts reaching 100, the need to equip and manage 100 drop ports and 100 add ports presents a serious expense and fiber management problem. A dynamic, flexible OADM meets the requirements because it can connect any optical channel in the system to any add or drop fiber in the node under remote electronic control. Thus it only needs as many drop and add ports as the number of channels to be dropped or added. Previous dynamic OADM designs, however, have been very expensive and introduced too much loss into the system to be used without the addition of expensive optical amplifiers. Moreover, no existing designs provide integrated, in-service OPM.

As noted briefly above, another type of OADM is the reconfigurable OADM (ROADM). A ROADM can be remotely controlled to electronically change the channels to be added or dropped at a node. A ROADM is herein defined as a device that can add or drop any channel (wavelength) in the system but each channel must go from/to a predetermined add or drop port. Thus a ROADM lacks flexibility and requires an add/drop port for every wavelength in the system. The cost, size, and fiber management problems of a ROADM become serious if the number of wavelengths (i.e., channels) in the system increases to more than 20-30. These levels have already been exceeded in long-haul DWDM systems and will soon be reached in metropolitan systems. Another disadvantage of the ROADM is that it still requires technicians to install transceivers for a particular wavelength at a node before that wavelength can be originated and terminated at the node. Pre-positioning a significant amount of equipment in anticipation of when that wavelength will be needed at that node leads to unacceptable capital costs.

### SUMMARY

In accordance with the invention, an optical add/drop multiplexer unit is provided having: a network input port for receiving optical channels from an adjacent node; a network output port for transmitting optical channels to neighboring nodes; an add port for inserting information into the adjacent node; and a drop port for removing information from the adjacent node. The unit includes an electronically controllable beam steerer for receiving multiple channels of optical energy at the network input port and optical energy at the add ports and for directing the optical energy of selected channels at the network input port to either the network output port to provide transmission through the unit or the drop port; and for directing the optical energy from the add port to the network output port.

In one embodiment, the beam steerer used to selectively direct the optical channels comprises an optical phased array (OPA).

In one embodiment, an optical communication system is provided having an add/drop node. The add/drop node includes: network or system input ports for receiving optical information from neighboring nodes in the system; network or system output ports for coupling to destination nodes in the system; add ports for coupling additional optical channels into the system; and drop ports for coupling optical channels out of the transport network. The communication system includes an electronically controllable beam steerer for receiving optical energy at a network or system input port and optical energy from add ports, and for selectively directing the optical energy incident at the network or system input port to a network or system output port or to the drop ports; and directing the optical energy at the add port to a network or system output port.

In one embodiment, an optical communication system is provided having an add/drop node. The add/drop node includes: a network or system input port for receiving optical energy having a plurality of different optical wavelengths from other nodes in the network; a network or system output port for coupling to destination nodes in the network; add ports for receiving optical energy having a plurality of different optical wavelengths for insertion into the network; and a drop port that makes optical energy from the network available locally. Also provided is an electronically controllable beam steerer for receiving the optical energy having the plurality of different optical wavelengths at the network or system input port and the optical energy having the plurality of different wavelengths from the add ports, and for selectively: directing the optical energy having the plurality of different optical wavelengths at the network or system input port to the network or system output port or to the drop ports; and directing the optical energy having the plurality of different optical wavelengths from the add port to the network or system output port.

Thus, with the invention, a dynamic, flexible OADM is provided having the requisite functionality but at the cost of the relatively inexpensive fixed OADM. The low cost results from the use of mature semiconductor and liquid crystal display processing technology to fabricate the OPA together with reduced assembly tolerances made possible by the self-adjusting capability of the OPA. In addition, the OADM according to the invention has a relatively low insertion loss, comparable to that of the fixed OADM, which reduces the need for expensive optical amplifiers. The OADM according to the invention integrates the function of a wavelength multiplexer/demultiplexer with that of an optical cross-connect. In one embodiment of the invention, the wavelength multiplexer/demultiplexer uses a bulk Echelle diffraction grating to provide high throughput and low polarization sensitivity at a very low cost. The optical cross-connect uses the optical phased array (OPA) to steer the optical energy beams fed to the OADM corresponding to individual optical channels. The OPA provides stable, precise, open-loop steering of optical energy (i.e., light) beams and is superior to micro electro-mechanical systems (MEMS) based devices because it can also operate as an electronic lens and beam splitter. While attempts have been made to use MEMS in an OADM context, successful commercialization of such systems remains elusive. The electronically controlled lensing function of the OPA supports optimizing and controlling the coupling of lightwave signals between freely propagating beams and optical fibers. The beam-splitting capability of the OPA enables in-service OPM by directing a small fraction of the signal power from the optical channels to an optical detector for monitoring purposes. This capability of the OPA allows the device to also provide one-to-many fanout of a channel for optical multicasting. In addition, OPA-based devices do not require the closed-loop control required by 3-dimensional MEMS, have looser alignment tolerances than 2-dimensional MEMS, and have higher optical power handling capability than any MEMS-based device.

Although the invention is described in terms of dynamic OADMs, which are the most complex and capable type, it also applies to static, reconfigurable, and all simpler types of OADMs. This use of the OPA extends beyond that of switching (e.g., optical cross-connects) described in prior art by integrating the add/drop/express and optical performance monitoring functions, as described below. The addition of the multiplexing/demultiplexing-related functions requires a completely different design from that used for switching.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatical sketch of an optical communication system according to the invention;

FIG. 2 is a diagrammatical sketch of an optical add/drop multiplexer (OADM) used in nodes of the system of FIG. 1 according to the invention;

FIG. 2A is a launcher used in the OADM of FIG. 2;

FIG. 2B is a beam steering system used in the OADM of FIG. 2;

FIGS. 3A and 3B are top and side views, respectively, of a functional diagram showing operation of the OADM of FIG. 2 performing an ADD operation;

FIGS. 4A and 4B are top and side views, respectively, of a functional diagram showing operation of the OADM of FIG. 2 performing a DROP operation;

FIGS. 5A and 5B are top and side views, respectively, of a functional diagram showing operation of the OADM of FIG. 2 performing an Express operation;

FIGS. 6A and 6B are top and side views, respectively, of a functional diagram showing operation of the OADM of FIG. 2 performing a combined DROP, ADD, and Express operation;

FIG. 7 is a top view of a functional diagram showing a multicast operation of the OADM of FIG. 2;

FIG. 8 is a side view of a functional diagram showing a single-fiber, bi-directional operation using the same wavelength in both directions of the OADM of FIG. 2;

FIG. 9 is a side view of a functional diagram showing a single-fiber, bi-directional operation using a different wavelength in each direction of the OADM of FIG. 2;

FIG. 10 is a block diagram of a protection switching system that ensures continuing operation in event of a failure of the OADM of FIG. 2;

FIG. 11 is a diagram of a two-fiber, unidirectional DWDM ring using the OADMs of FIG. 2 in normal operation;

FIGS. 12A is a functional diagram showing operation of OADM 1 of FIG. 11 in normal operation;

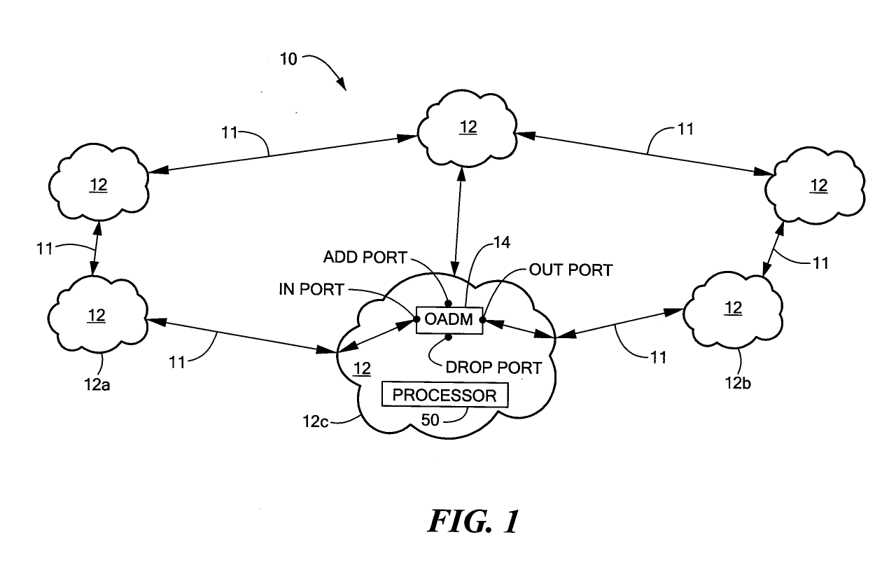

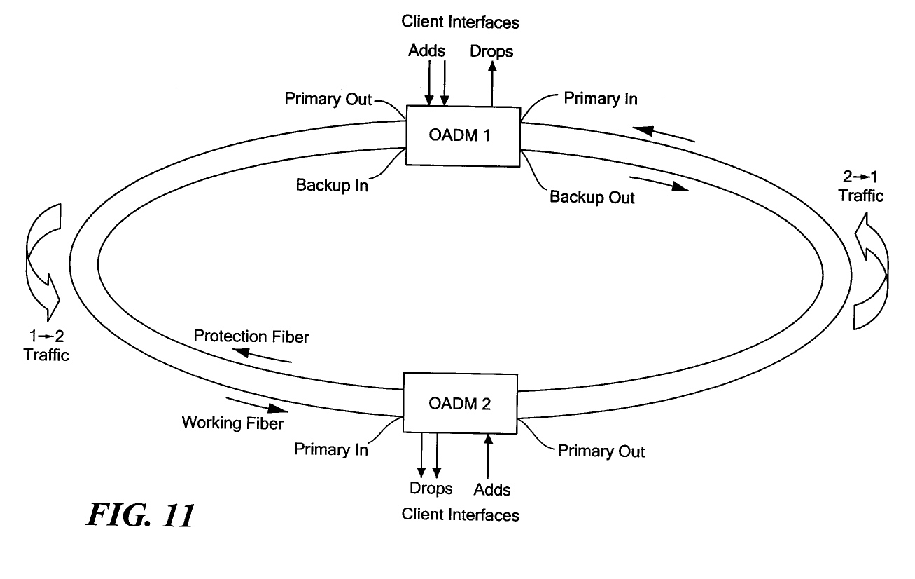

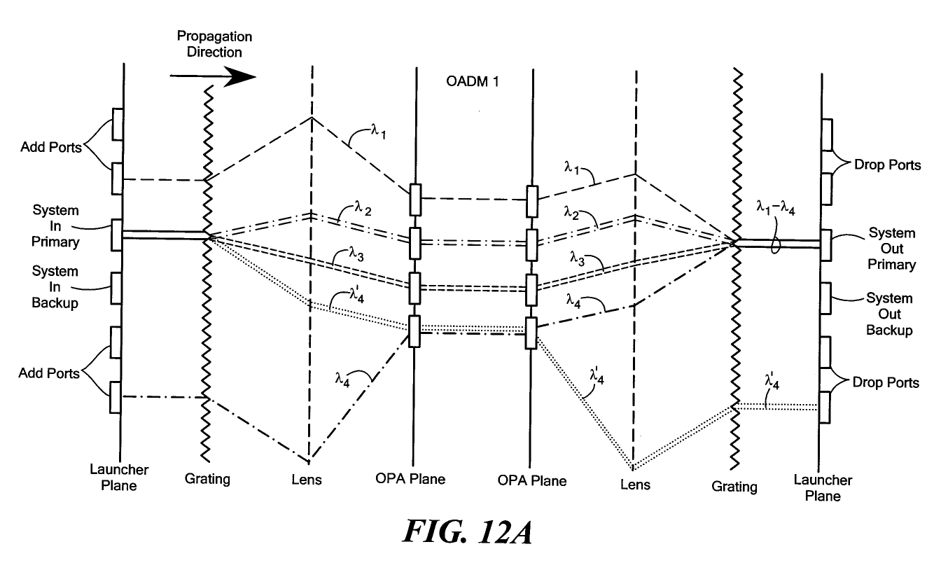

FIGS. 1 2B is a functional diagram showing operation of OADM 2 of FIG. 11 in normal operation;

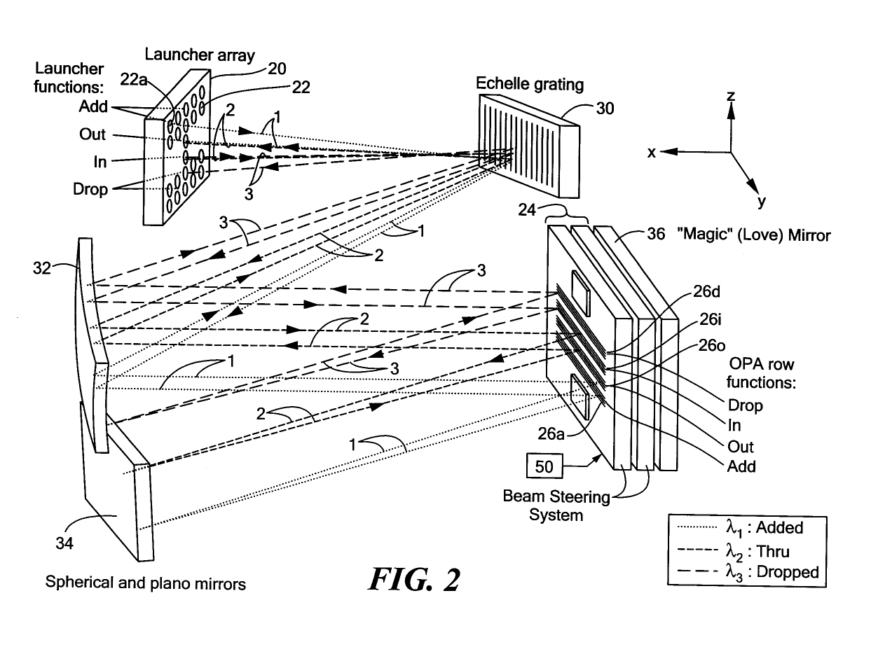

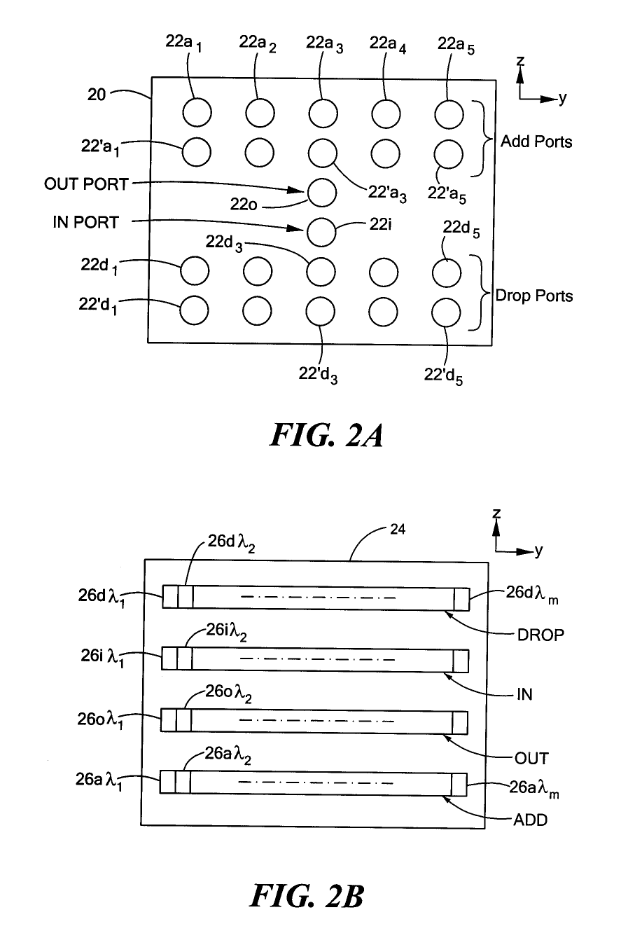

FIG. 13 is a diagram of a two-fiber, unidirectional DWDM Ring using the OADMs of FIG. 2 in which a Fiber Break has occurred;

FIG. 14A is a functional diagram of a configuration of OADM 1 for DWDM Ring of FIG. 13 with Fiber Break;

FIG. 14B is a functional diagram of a configuration of OADM 2 for DWDM Ring of FIG. 13 with Fiber Break;

FIG. 15 is a functional diagram illustrating how the OADM of FIG. 2 can be adapted to perform optical performance monitoring of the system of FIG. 1:

FIG. 16 is a diagram showing Reflective-Mode Embodiment of the OADM of FIG. 2 with Power Equalization Operation;

FIG. 17 is a diagram comparing ITU-T 200-GHz-spacing DWDM data wavelengths for C- and L-Bands to position and uncertainty of 1510-nm and 1625-nm optical service channels (OSC's);

FIG. 18 is a diagram of a launcher array as used in the OADM of FIG. 2 adapted to manage the optical service channel (OSC);

FIG. 19 is a diagram of a plane of an optical array (OPA) system used in the OADM of FIG. 2 adapted to manage the optical service channel (OSC);

FIGS. 20A and 20B are top and side views, respectively, of a functional diagram showing operation of the OADM of FIG. 2 adapted to manage the OSC showing the process for adding (solid lines) and dropping (dashed lines) an OSC.

Like reference symbols in the various drawings indicate like elements.

### DETAILED DESCRIPTION

Referring now to FIG. 1 an optical communication system 10 is shown to include a plurality of similar nodes 12 interconnected by fiber optic cables 11. For purposes of discussion, here we will consider three of the nodes; the nodes labeled 12a, 12b and 12c. With respect to node 12c, node 12a is referred to as a source node and node 12b is referred to as a destination node. It is understood that the communication between the nodes 12 is, however, bi-directional. It is also noted that the nodes 12 include an optical add/drop multiplexer (OADM) 14 shown in more detail in FIG. 2. Suffice it to say here, however, that the OADM 14 has four types of ports as shown for node 12c: An input port (IN port, sometimes referred to as a System-In Port or network input port); an output port (OUT port, sometimes referred to as a System-Out Port or network output port; an ADD port; and a DROP port. In response to electrical signals fed to the OADM 14 from a controller 50, the OADM 14 is adapted to perform the following functions: “express” wherein optical energy in a subset of a plurality of m, where m is an integer, different optical wavelengths, or channels, pass through the node (e.g., from the source node 12a through the node 12c to the destination node 12b); “drop” wherein optical energy in a subset of the plurality of the m different optical wavelengths, or channels, pass from the IN port to the DROP ports; “add” wherein optical energy in a subset of the plurality of m different optical wavelengths, or channels, pass from the ADD ports to the OUT port. As will be described, the OADM 14 is adapted to perform various combinations of these functions.

Referring now to FIG. 2, the OADM 14 includes a launcher 20 having a plurality of ports 22. More particularly, it is noted that here, in this example, the launcher 20 includes six rows of the ports 22 disposed substantially in the Y-Z plane. Here, the top two rows of the ports 22 each have for example, five ports 22 and are ADD ports, shown in FIG. 2A as ports 22a1-22a5 in the top row and ports 22′a1-22′a5 in the next lower row. The ports 22 in the top two rows correspond to the ADD ports. Here, the bottom two rows of the ports 22 each have for example, five ports 22, shown in FIG. 2A as ports 22d1-22d5 in the next to the bottom row and ports 22′d1-22′d5 in the bottom row. The ports 22 in the bottom two rows are the DROP ports. In this example, there is one port 22 in the third row from the top of the launcher 20, and this is the OUT port, here port 22o. Finally, in this example, there is one port 22 in the fourth row of from the top of the launcher 20, and this is the IN port, here labeled 22i.

The optical energy fed to the IN ports and ADD ports 22 is adapted to carry the plurality of here m channels. Each channel carries information modulated onto a different one of a plurality of optical wavelengths, i.e., wavelengths λ₁-λₘ. Again, it is noted that while the designations IN port and OUT port are used, the ports 20 are bi-directional.

The OADM 14 (FIG. 2) includes an electronically steerable optical beam steering system 24. The beam steering system 24 is here a two-dimensional beam steering system adapted to steer an incident beam of optical frequency energy, i.e., light, in azimuth (i.e., the X-Y plane) and elevation (i.e., the X-Z plane) in response to electrical control signals fed thereto by the controller 50. One such beam steering system is described in U.S. Pat. No. 5,093,740 entitled “Optical Beam Steerer Having Subaperture Addressing” issued Mar. 3, 1992, inventors Dorschner et al, U.S. Pat. No. 5,963,682 issued Oct. 5, 1999, inventors Dorschner et al., and U.S. Pat. No. 6,704,474 issued Mar. 9, 2004, inventors Dorschner et al. all assigned to the assignee of the present patent application, the entire subject matter of all such U. S. Patents being incorporated herein by reference. As described therein, the beam steering system includes an array of optical phase shifters. The phase shift provided to that portion of a beam of optical energy which passes through each phase shifter is selected by an electrical control signal fed to the phase shifter, here by the controller 50. An incident beam of optical energy, as from a laser, is thereby angularly directed (i.e., deflected) in accordance with the spatially varying phase shift provided by the array of phase shifters. Other types of electronically controllable beam steerers may be used.

Here, the beam steering system 24 has four sections 26d, 26i, 26o, and 26a arranged in rows, as shown. Each one of the sections 26a, 26o, 26i, 26d corresponds to one of the four types of launcher ports 22 (i.e., ADD ports, OUT ports, IN ports, DROP ports, respectively) of the launcher 20. Thus, the ADD ports, OUT ports, IN ports, DROP ports of launcher 20 correspond to section 26a, 26o, 26i, and 26d, respectively. In addition, a Love mirror 36 is included, such as that described in an article entitled “Liquid crystal phase modulator for unpolarized light,” by Gordon Love, published in Applied Optics, Vol. 32, No. 13, May 1993. Lightwaves encountering the beam steering system 24 then pass to the Love mirror 36 and are reflected back through the same portion of the beam steering system. The Love mirror flips the polarization such that a given lightwave beam of any polarization is steered without regard for the polarization, notwithstanding that the beam steering system 24 may have polarization-sensitive properties. In the preferred embodiment, beam steering in either the vertical or horizontal directions is effected by means of two one-dimensional beam steerers, with the Love mirror positioned behind the stack of two beam steerers. An incident beam thus passes through two beam-steerers, reflects off the Love mirror, and then emerges after passing back through the same two beam-steerers.

Each one of the rows of beam steering system 24, i.e., each one of the sections 26d, 26i, 26o, 26a includes a plurality of, here m, beam steerers 26, as shown in FIG. 2B. Each one of the m beam steerers 26 is associated with a corresponding one of the m optical channels or wavelengths λ₁-λₘ. Thus, each one of the sections 26d includes beam steerers 26dλ₁-26dλₘ for steering beams in a corresponding one of the m wavelengths λ₁-λ_{m.}, and likewise sections 26i, 26o, and 26a include beam steerers for each wavelength.

An optical arrangement (FIG. 2) having a dispersive element 30, preferably an Echelle diffraction grating, and mirrors 32, 34, and 36, is provided for directing optical energy between launcher ports 22 types (i.e., DROP ports, IN ports, OUT ports, and ADD ports) and the associated one of the plurality of beam steering sections 26d, 26i, 26o, 26a, respectively, with each one of the plurality of the optical wavelengths λ₁-λₘ of such directed optical energy at the IN ports and the ADD ports being directed to the corresponding one of the beam steerers 26dλ₁-26aλₘ associated with such one of the plurality of optical wavelengths λ₁-λₘ, respectively. As noted above, each one of the sections 26d, 26i, 26o, 26a corresponds to one of the four types of launcher ports 22 (i.e., DROP ports, IN ports, OUT ports, ADD ports, respectively) of the launcher 20. Thus, the DROP ports, IN ports, OUT ports, and ADD ports of launcher 20 correspond to DROP section 26d, IN section 26i, OUT section 26o and ADD section 26d. Dispersive element 30 may be an Echelle grating, a dispersive element of the Virtually Imaged Phased Array (VIPA) type, a normal diffraction grating, or other grating type.

More particularly, optical energy from node 12a of the optical communications system in FIG. 1 to be either dropped or expressed is fed to port type IN. Optical energy to be inserted into the optical communications system in the direction of node 12b in FIG. 1 is fed to port type ADD. The energy at port type IN is, as noted above, directed to section 26i and the energy at port type ADD is directed to beam steerer section 26a. The associated one of the plurality of beam steering system sections 26i and 26a, respectively, (i.e., section 26i associated with the IN ports type or section 26a associated with the ADD port type) receives the directed, i.e., incident energy, via the grating (or other dispersive element) 30 and mirror 32 and, selectively in accordance with the electrical signals fed to the beam steering system 24 by the controller 50 to provide a selected one of the system functions (i.e., out or drop), re-directs the incident optical energy via mirror 34 to the one of the sections 26d, 26o corresponding to the one of the types of launcher ports 22 (i.e., DROP ports or OUT ports) associated with the selected one of the functions and more particularly to the beam steerers 26 in such one of the sections 26d, 26o associated with the wavelengths of such energy. The energy is steered by the beam steering system 24 selectively in accordance with the electrical signals provided by the controller 50 so that such steered energy will pass, via the mirror 32 and Echelle diffraction grating 30, to the one of the launcher port 22 types associated with the selected one of the system functions. Thus, for an “express” operation, energy incident on section 26i will be steered by the beam steering system 24 and directed by the mirror 32 and grating 30 to the port type OUT; for an “add” operation, energy incident on section 26a will be steered by the beam steering system 24 and directed by the mirror 32 and grating 30 to the port type OUT; for a “drop” operation, energy incident on section 26i or 26a will be steered by the beam steering system 24 and directed by the mirror 32 and grating 30 to the port type DROP.

Consider now an add function. Here, energy at the ADD port 22 is to be coupled to the OUT port 22 of the launcher 20. Thus, optical energy, here for example having a wavelength λ₁, is fed to one of the ADD ports 22, here designated as port 22a. This energy may, for example, come from node 12a in FIG. 1. The path of the optical energy at port 22a having the wavelength λ₁ is shown by the arrow labeled 1 in FIG. 2. Thus, such energy passes to the grating 30 where it is directed to the mirror 32. The mirror 32 re-directs the energy to the beam steering system 24 and more particularly to section 26a and still more particularly to the one of the beam steerers 26aλ₁ in section 26a associated with the wavelength λ₁. In response to control signals from processor 50, the beam steering system 24 steers the energy incident thereon to the section 26o (i.e., section 26o being associated with the OUT ports 22 of the launcher), via mirrors 36 and 34 and still more particularly to the one of the beam steerers 26oλ₁ in section 26o associated with the wavelength λ₁. The beam steering system 24 then steers the beam from section 26o to the OUT port via the mirror 32 and grating 30.

It should be noted that while the embodiment here being described has a single IN and a single OUT port, multiple such ports could be supported just as multiple ADD and DROP ports are supported. This would result in a system having the functionality of a multi-port wavelength-selective switch wherein a given wavelength inserted at an ADD or IN port could be steered under electronic control to any DROP or OUT port or to multiple ports simultaneously.

Similarly, other examples are illustrated in FIG. 2: Energy at wavelength λ₂ at IN port 22 is coupled to the OUT port 22 to effect an “express” operation as indicated by the path labeled 2 having energy incident on section 26i and then steered to section 26o, then steered to OUT port 22. Energy at wavelength λ₃ at IN port 22 is coupled to the DROP port 22 to effect a “drop: operation as indicated by the path labeled 3 having energy incident on section 26i and then steered to section 26d and then to DROP port 22.

More particularly, while one launcher 20 is shown in FIG. 2, one or more optical launchers 20 may be used. The launcher 20 is preferably an array of micro lenses, lenslets, or GRIN lenses that approximately collimates within the device input optical energy that emanates from the System-In and Add optical fibers. Thus, each lenslet corresponds to one of the ports 22. In addition, they focus approximately collimated optical energy arriving at the launcher 20 into the system-out and drop type ports 22 (i.e., the OUT ports and DROP ports). All optical beams that enter or leave the OADM 14 do so by means of the launchers 20. Each of these connections at a launcher 20 between an optical fiber and a beam entering or leaving the OADM 14 is, as noted above, referred to as a port 22.

It should be noted that each launcher is a bidirectional device, i.e. lightwaves may be coupled from the fiber attached to a given launcher into a free-space beam or lightwaves incident on the launcher from the exterior may be coupled into the fiber attached to the launcher. These launchers are “single-mode” device, i.e., in order that a lightwave beam be coupled into the fiber of a given launcher, that beam must be incident at the correct angle and also the correct position.

The launcher 20 is designed, as noted above, such that there are arrays of ports 22 corresponding to add fibers (ADD ports) and arrays of ports corresponding to drop fibers (i.e., DROP ports). In the preferred embodiment only one wavelength (optical channel) is present at a given Add or Drop Port at a given time, although the particular wavelength can be selected from any in the system. The system includes cases in which multiple wavelengths can be present at a given port. For most applications the number of ADD ports 22 will equal the number of DROP ports 22; it being understood, however, that the invention includes cases where they are not equal. There are also, as described above, one or more IN ports 22 and one or more OUT ports 22 that attach the device to the transmission fibers of cables 11 (FIG. 1) that connect it to the adjacent network nodes 12. These ports carry wavelength multiplexed beams. Although FIG. 2 shows the ADD, DROP, IN, and OUT ports 22 grouped together in regular arrays to improve the efficiency and simplify the construction of the device, the invention also includes implementations in which the types of ports are mixed together or the arrays have a different arrangement with respect to each other.

While the system in FIG. 2 shows one Echelle diffraction grating 30, it should understood that more than one diffraction grating 30 may be used. The gratings preferably are bulk Echelle diffraction gratings 30 which operate at near-Littrow condition (i.e., the light diffracted by the grating travels approximately in the opposite direction as the incident light) and are included to disperse or combine the optical energy of different wavelengths. The optical energy from the ADD ports 22 and the IN ports 22 is incident upon the grating and different wavelengths are diffracted at different angles. Optical energy from the OPA system 24 destined for the DROP ports 22 and OUT port is incident upon the grating at different angles and is diffracted into the appropriate DROP port or combined into the OUT port. An Echelle diffraction grating is used because its diffraction efficiency has lower sensitivity to polarization than other types of gratings. Likewise a VIPA device could be used and confers similar performance advantages. In FIG. 2 the grating grooves are vertical (i.e., along the Z axis), resulting in the dispersion of different wavelengths being horizontal (i.e., in the X-Y plane). The invention includes embodiments in which the grooves are oriented in other directions. While FIG. 2 illustrates the grating operated in reflective mode, it can also be operated in transmissive mode.

The mirror 32, which may be one or more mirrors, are here concave mirrors and direct the optical energy diffracted from the grating 30 onto the OPA system 24 and mirror 36 and direct optical energy from the OPA system 24 to the grating 30. In the preferred embodiment of the invention the curvature and position of the mirrors 32 are selected such that they are separated by one focal length from the grating and the plane of the OPA system 24 array. This serves the purpose of having beam angles at one plane transformed into beam spatial position at the other plane. Other configurations of position and focal length are included in this invention. The function of these mirrors can also be performed by lenses.

One or more arrays of OPA system 24 apertures (i.e., the beam steerers 26) are used to steer the beams and split the beams for OPM and optical multicasting. The OPA system 24 apertures (i.e., the beam steerers 26) are arranged in columns and rows. An aperture is designated by a letter, i.e., d, i, o, or a, and a wavelength designator, i.e. λ1, λ2, λm. Thus the aperture in the d row and the λ1 column is designated 26dλ1. Each column of the array e.g., such columns being disposed in section 26λ1 in FIG. 2B) corresponds to a specific wavelength of the optical system if the gratings are arranged to disperse in the horizontal direction (i.e., X-Y plane). Each row (e.g., such rows being disposed in section 26a in FIG. 2B) corresponds to a beam state: system-in, system-out, add, and drop.

More particularly, for each beam coming from the launcher array, the vertical angle (i.e., angle away from the XY plane) of each launcher governs the vertical position where the beam strikes the beam steering system. That is, vertical launcher angle is in a one-to-one relationship with beam steering system row. The horizontal angle (i.e., the angle away from the XZ plane) is controlled by the wavelength-dependent angular deflection imposed by the diffraction grating and thereby governs which column of the beam steering system is struck by the beam, which thereby is in a one-to-one relationship with wavelength. These one-to-one relationships apply both for light beams traveling from the launcher array to the beam steering system and also for light beams traveling in the reverse direction. Whether a given beam of a given wavelength coming from one type of launcher, e.g., an INPUT port, is sent to the OUTPUT port or to a DROP port depends on the angle through which the beam is steered by the OPA in the INPUT row. This OPA is controlled to steer horizontally so as to cancel the wavelength-dependent horizontal angle and to apply a vertical deflection angle such that the beam, after reflection off mirror 34, strikes the OPA in the same column and in the chosen (OUTPUT or DROP, respectively) column. Finally, that OPA must impose the correct vertical angle to correspond to the vertical position of the chosen launcher and simultaneously the horizontal angle which cancels the deflection the beam will then encounter at the grating, as well as an additional horizontal angle chosen to select the correct horizontal position of the desired OUTPUT or DROP port respectively. The column used by a specific beam is dictated by its wavelength and does not change within the device. Additional OPAs may be included for steering the optical service channel beams. The beam-steering system, comprising here two sets of OPA's and one Love mirror and illustrated in FIG. 2, operates in reflective mode. A beam-steering system operating in transmission mode can also be used.

It should be noted that the operation just described results in the impossibility of coupling signals of the same given wavelength from two different sources (e.g., ADD and INPUT) into a single output. Even if the OPA at the given wavelength in the ADD row directs its beam (via mirror 34) to, say, the OUTPUT row and simultaneously the OPA at the given wavelength in the INPUT row directs its beam also to the OUTPUT row, the OPA in the OUTPUT row will impose some chosen vertical angular deflection on the two beams incident thereupon. The two beams being incident at different angles will thereby exit at two different angles and thus will be directed to different positions on the launcher array and cannot be directed to the same launcher. Likewise, since the launchers are single-mode devices (as described above), it will be seen that if a beam having a given wavelength is sent from a column corresponding to some other wavelength, it cannot be coupled into any launcher. This is most easily seen by making use of the fact that the propagation of lightwaves within the system is independent of whether the lightwaves are traveling from left to right or from right to left along any given path. It is clear from the operation of the mirror 32 and the grating 30 that a lightwave beam of a given wavelength emerging from a given launcher is connected directly to a single OPA. Thus for lightwaves propagating in the reverse direction, i.e., toward the launcher, only lightwaves of that given wavelength and coming from that single OPA will be coupled into the given launcher.

While one mirror 34 is shown, the system may include more than one such mirror. One or more folding mirrors 34, here a plano mirror, are included in this OADM 14. The purpose of these mirrors 34 is to reverse the path of the optical energy incident upon them, sending it back through the OADM 14 to complete the beam operations needed for routing the optical channels. The use of a folding mirror 34 reduces the size and component count of the device by double passing most components. This invention includes other configurations that do not use folding mirrors or which replace them with lenses.

A compensator for polarization-dependent loss (PDL) may be included in the OADM 14. The diffraction grating and other optical components may produce a residual PDL. This can be compensated to first order by introducing mechanism for rotating the plane of polarization of the optical energy at a symmetry plane within the OADM 14. In the folded design the optimum position is at the folding mirror. In a transmissive design the optimum position is at the equivalent position, which is the center plane of the device.

An electronic controller 50 (FIG. 2) for the beam steering system 24 translates the beam manipulation function commanded by the system into the voltages applied to the electrodes of the beam steerers 26 of the OPA system 24.

Referring again to FIG. 2, optical energy (i.e., light) from the upstream, or source network node 12a (FIG. 1) enters the OADM 14 via the IN port 22 on the launcher array 20 and is directed to the diffraction grating 30. This beam consists of many wavelength-multiplexed optical channels. These channels are dispersed at the grating, each wavelength being diffracted at a different angle. The concave mirror 32 directs these beams to the System-In row of the OPA system 24, each optical channel being directed to the aperture (i.e., beam steerer 26) for its wavelength. Each OPA aperture 26 imparts a vertical deflection to the incident beam (i.e., a deflection in the X-Z plane, elevation) corresponding to the intended disposition of that beam. If it is to be dropped, energy at IN port 22 of the launcher 20 is directed to section 26i and then the OPA system 24 generates an upward deflection which causes it to reflect off the folding mirror 34 and strike the corresponding column in the drop row (i.e., section 26d) of the OPA system 24. The beams thereby incident on the drop row (i.e., section 26d) are given the appropriate vertical and horizontal tilt such that after being reflected off the curved mirror 32 and diffracted by the grating 30, they arrive at the 5 chosen DROP port at the launcher array 20. If a beam is to be expressed through the node, the OPA system 24 causes a downward deflection at the system-IN row (i.e., section 26i), directing it via the folding mirror 34 to the OUT row, i.e. 26o of OPA 24, which in turn causes it to impinge on the OUT port 22. These apertures (i.e., the beam steerers 26 in the section 260) provide the correct deflection for these separate beams to be combined into one beam at the grating and directed to the OUT port. In similar fashion, beams emanating from the ADD ports are diffracted at the grating and directed by the curved mirror 32 onto the apertures corresponding to their wavelength in the ADD row (i.e., section 26a). These apertures 26 provide a vertical deflection causing the beams to reflect off the folding mirror 34 and impinge on the OUT row 26o. From this point the add beams follow the same path as described above for the express channels: They are combined into one at the grating and directed to the OUT port. Optical energy is directed to the Monitor Ports to be described in more detail in connection with FIGS. 15-19 by instructing the appropriate OPA apertures 26 to diffract a small fraction of the incident optical energy to a Monitor Port while the majority of the optical energy is steered to a OUT port. In addition to the folded design in FIG. 2, other embodiments of the invention can substitute lenses for mirrors, transmission gratings for reflective gratings, and transmissive OPAs for reflective OPAs in various combinations.

With the embodiment of FIG. 2 it is possible to add a channel and drop it at the same node. This particular embodiment does not allow the erroneous state of trying to add a wavelength while also trying to express it through; both the add channel and the express channel would reach the same OPA aperture in the System-Out row, but the vertical tilt can only be set to direct one of the two to the OUT ports. Thus one of the beams will be dumped, preventing them from both being coupled into the transmission fiber and interfering at the downstream node that terminates that wavelength.

The embodiment illustrated in FIG. 2 uses mirrors and operates the OPAs in a reflective mode to reduce component count and the overall size of the device. This invention, however, applies equally to embodiments using transmissive components. To demonstrate this, and because it is easier to illustrate and explain transmissive operation, the detailed operation of the invention discussed above used and the discussion below will use a transmissive mode design.

### Channel Add Operation

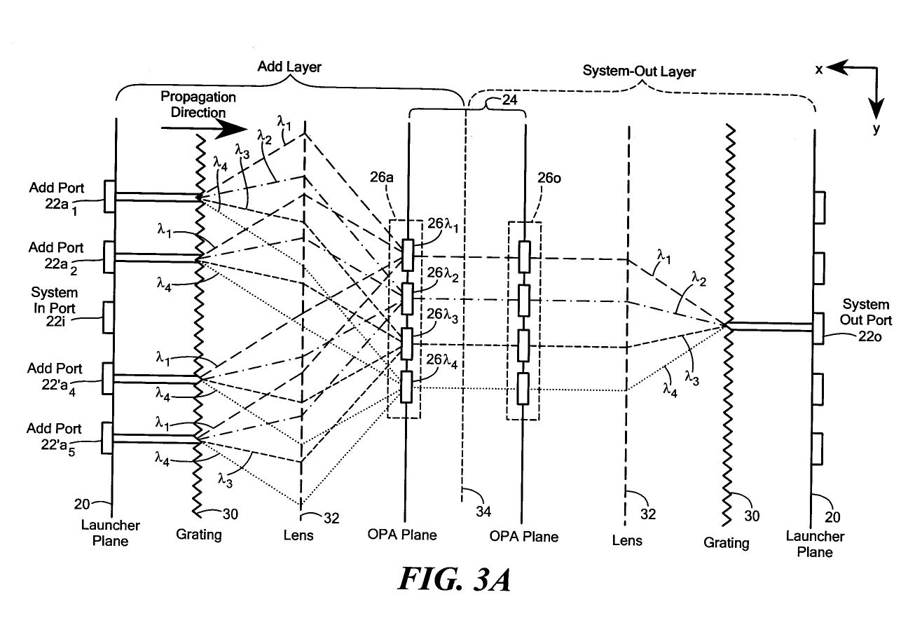

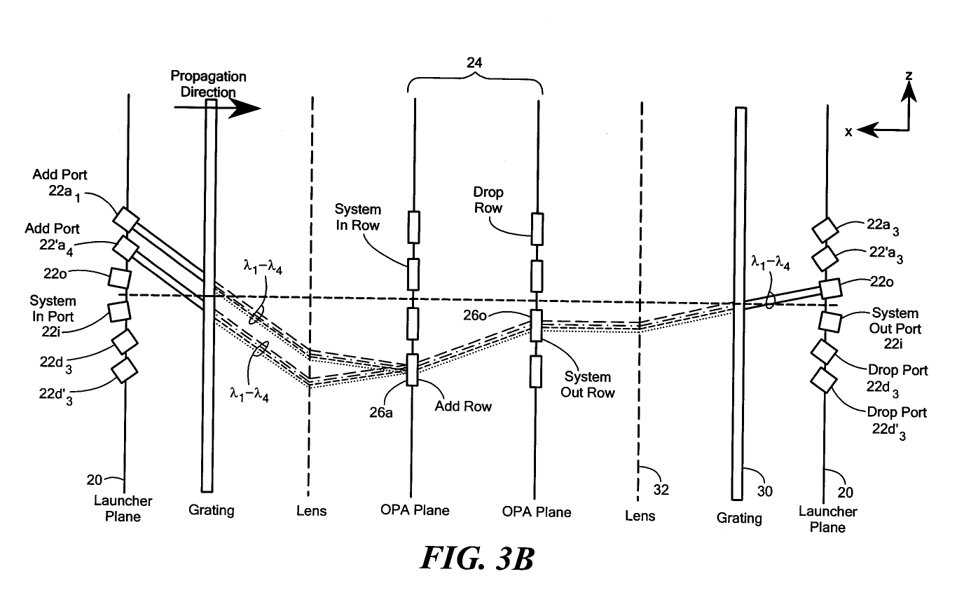

Referring now to FIGS. 3A and 3B, such FIGS. are top and side functional views, respectively, of a transmissive mode OADM 14 illustrating the process of adding an optical channel. The equivalence to FIG. 2 is established by placing the folding mirror 34 equidistant between the two OPA system 24 planes, one plane 51 representing the incident energy from lens (i.e., mirror in FIG. 2) 32 and the other plane 53 representing the incident energy from mirror 34. Note that in figures after FIG. 3A the position of the mirror 34 is not shown; it is understood that this folding plane lies in the center of all subsequent such diagrams. Thus propagation proceeding to the right of this mirror plane in FIG. 3A corresponds to propagation back through the preceding elements in FIG. 2. For the folded and transmissive designs to be equivalent in detail, the components and their placement to the right of the central plane in FIG. 3A must be identical to those on the left. However, this is not necessary for a general embodiment of a transmissive design. The grating 30 is shown in transmissive mode and the curved concave mirror 32 has been replaced by its transmissive equivalent, a positive lens. The OPAs are also shown in transmissive mode while in FIG. 2 they are in reflective mode. When converting between transmissive and reflective mode one changes the type of components to their equivalent in the other mode (e.g., from lens to mirror) and also rearranges the positions of the components with respect to each other. Details of channel operations are illustrated using a transmissive mode embodiment because the diagrams are easier to interpret.

As noted above, each one of the sections 26d, 26i, 26o, 26a corresponds to one of the four types of launcher ports 22 (i.e., DROP ports, IN ports, OUT ports, ADD ports, respectively) of the launcher 20. Thus, the DROP ports, IN ports, OUT ports, and ADD ports of launcher 20 correspond to DROP section 26a, IN section 26i, OUT section 26o and ADD section 26a, respectively. The different numerical designations of the OPAs in FIGS. 3A indicate their respective wavelengths (column in FIG. 2), and the four OPA system rows or sections, i.e., DROP section 26d; IN section 26i; OUT section 26o, and ADD section 26a are superimposed. In this example, four ADD type launcher 20 ports 22 are shown. Each one is shown receives four possible channels, i.e., wavelengths, λ₁, λ₂, λ₃ and λ₄. This is to illustrate that the ADD ports are capable of utilizing any wavelength; in actual operation, all the wavelengths illustrated would not necessarily be present. As noted above, each one of the beam steerers 26 is associated with a corresponding one of the wavelengths λ₁, λ₂, λ₃ and λ₄. Thus, here, in this example, the wavelengths λ₁, λ₂, λ₃ and λ₄ are associated with beam steerers 26 designated as beam steerers 26(d, i, o, or a)λ₁, 26(d, i, o, or a)λ₂, 26(d, i, o, or a)λ₃and 26(d, i, o, or a)λ₄, respectively. It is noted that energy of wavelength λ₁ is directed to the beam steerers 26aλ₁ of ADD section 26d of the OPA system 24, reference being made also to FIG. 2A to identify the ports. Likewise, energy of wavelength λ₂ is directed to the beam steerers 26aλ₂ of ADD section 26a of OPA 24, energy of wavelength λ₃ is directed to the beam steerers 26aλ₃ of ADD section 26a of OPA 24, and energy of wavelength λ₄ is directed to the beam steerers 26aλ₄ of ADD section 26a.

After being directed by the beam steering system 24 to mirror 32 and then reflected by mirror 34 so that the energy of wavelength λ₁ is directed from the beam steerers 26aλ₁ of ADD section 26a of the OPA system 24 to the beam steerer 26oλ₁ of OUT section 26o of the OPA system 24. Likewise, energy of wavelength λ₂ is directed from the beam steerers 26aλ₂ of ADD section 26a of OPA 24 to the beam steerers 26oλ₂ of OUT section 26o of OPA 24, energy of wavelength λ₃ is directed from the beam steerers 26aλ₃ of ADD section 26a of OPA 24 to the beam steerer 26oλ₂ of OUT section 26o of the OPA system 24, and energy of wavelength λ₄ is directed from the beam steerer 26aλ₄ of ADD section 26a to the beam steerer 26oλ₄ of OUT section 26o of the OPA system 24.

The OPA system 24 in FIG. 3B indicates the four beam state rows (26d, 26i, 26o, 26a) while the OPAs for different wavelengths are superimposed in this side view. The axes directions indicated in the upper right-hand corner conform to those shown in FIG. 2. Optical energy propagates in the X direction; the grating disperses in the Y direction; the OPA rows, e.g., 26a are parallel to the Y axis; the OPA columns for a given wavelength are parallel to the Z axis.

Input beams emanate from the ADD ports in the launcher 20 plane and impinge on the grating 30. Note that in FIG. 3B the launchers are at an angle in the X-Z plane. As described above, this angle results in the ADD beams all landing on the ADD row of the OPA's, i.e. 26a. The grating disperses the add beams, imparting a different angle in the x-y plane to each wavelength (shown with all wavelengths sharing the same path because the wavelength paths are one behind the other in this view). Although multiple wavelengths are illustrated for each ADD port, in practice it may be preferable to use only one per port. The invention supports both methods. The separation of wavelengths cannot be represented in FIG. 3B, but regions where beams for different wavelengths are separate are indicated by a lines drawn very close together. FIG. 3A shows the angle-to-position transformation, s between the grating 30 and OPA planes, which is provided by the lens 32. Thus a specific wavelength, no matter which port it emanates from, will be focused onto the same OPA aperture. However, its angle of incidence will be dependent upon the port from which it came. Each OPA steers its beam to eliminate further displacement in the y direction (i.e., to cancel this variable angle of incidence) so that it will impinge upon the second OPA for that wavelength (i.e., after reflection off mirror 34). It also provides steering in the z direction (FIG. 3B) such that the beam transitions from the ADD row to the OUT row. At the second encounter with the OPA 24, the OPA steers the beam to eliminate any further displacement in the z direction (FIG. 3B). In FIG. 3A the mirror 32, encountered for the second time, focuses the parallel beams for different wavelength to the same spot on the grating (angle-to-position), and the grating diffracts each wavelength by the amount needed to superimpose them in a single beam that is directed to the OUT port. This is more easily understood if one considers the reverse propagation, as mentioned above. The grating diffracts each outgoing wavelength by the correct amount since this is just the time-reversed action it performed on the input wavelengths.

### Channel Drop Operation

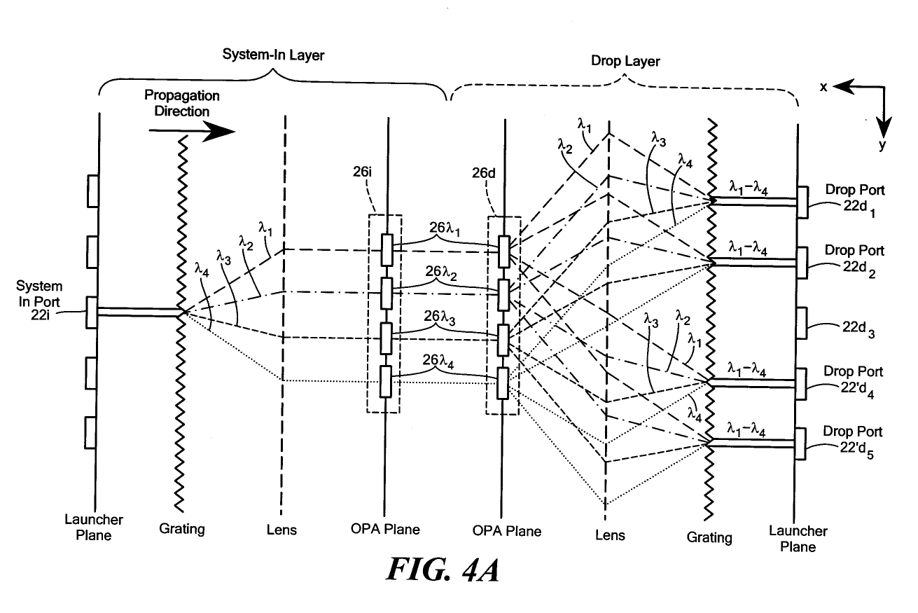

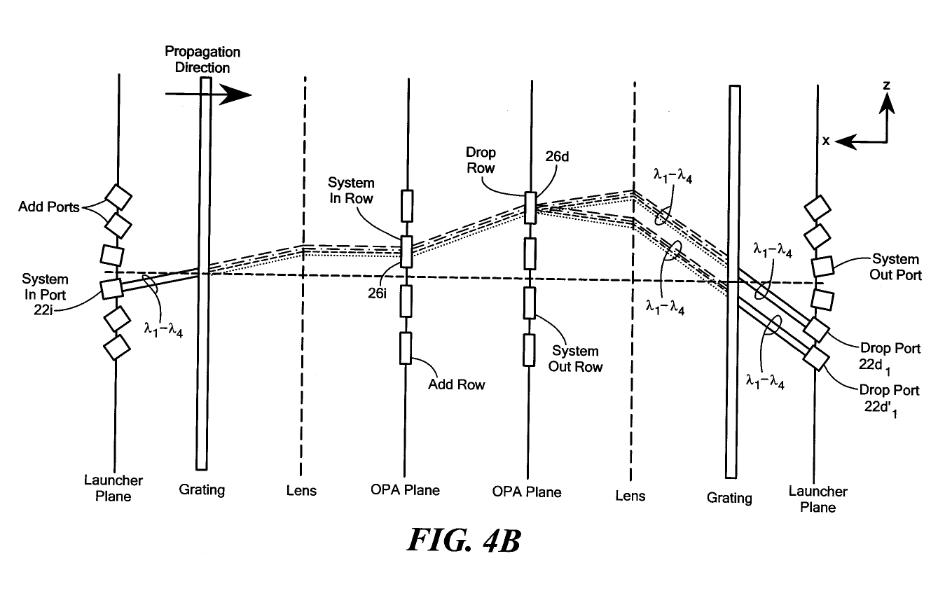

The process by which optical channels are dropped from the Dense Wavelength Division Multiplexed (DWDM) system is illustrated in FIGS. 4A and 4B, which are respectively top and side views as indicated by the coordinate axes shown at upper right. DWDM channels from the upstream node enter the OADM 14 at the System-IN port 22i, from where they propagate as a single beam to the grating. As shown in FIG. 4A, the grating disperses this beam such that each channel in it is diffracted at a different angle. The lens 32 directs these beams onto the “in” row 26i of the OPA system 24 (FIG. 4B) and to the aperture appropriate for each wavelength (FIG. 4A). Note that since all the beams emanate from the same point on the grating, they will be parallel after being refracted by the lens 32. The OPA system 24 imparts an upward angle in the x-z plane on the channels to be dropped, thereby causing them to impinge on the corresponding OPA apertures of the drop row i.e., section 26d of the second OPA plane. The particular DROP port 22d1-22′d5 to be used for a channel is determined by the combination of vertical and horizontal angles imparted to the beams by the aperture in the second OPA plane. FIG. 4A illustrates the capability to send any wavelength to any DROP port, but at any given time each aperture would usually use a single DROP port. From FIGS. 4A and 4B it is apparent that more than one optical channel can be sent to a given DROP port, each coming from a different OPA aperture. This may be a desirable feature if the operator intends to minimize the number of DROP ports and use a demultiplexer external to the device for separating the channels. If done unintentionally it will result in an error condition with multiple optical channels incident upon a single receiver. The software system that manages the device processor 50 (FIG. 2) distinguishes these situations and blocks configurations leading to errors.

### Channel Express Operation

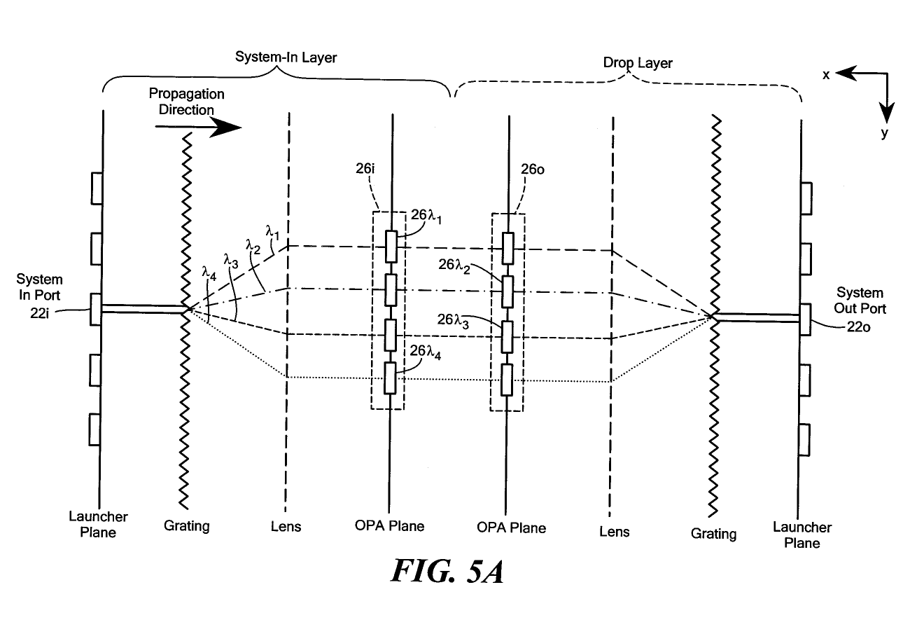

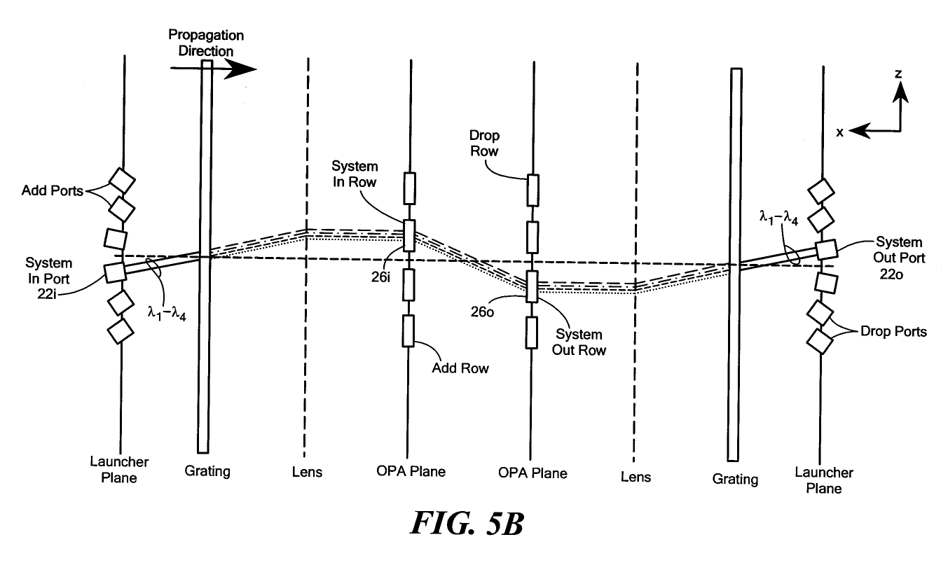

FIGS. 5A and 5B illustrate the mechanism by which DWDM channels are expressed through the node 12c, FIG. 1. The capability to pass an optical channel through a node without terminating and re-transmitting it electronically is the fundamental reason for developing OADMs. The wavelength multiplexed beam enters the device via the System-In Port and is diffracted into multiple beams that impinge on the system-in row of the first OPA plane. From here they are directed downward to the system-out row of the second OPA plane. The second lens focuses all beams to the same spot on the second grating, which then diffracts them into a single beam that exits through the System-OUT port.

### Example of Combined Drop/Add/Express Operation

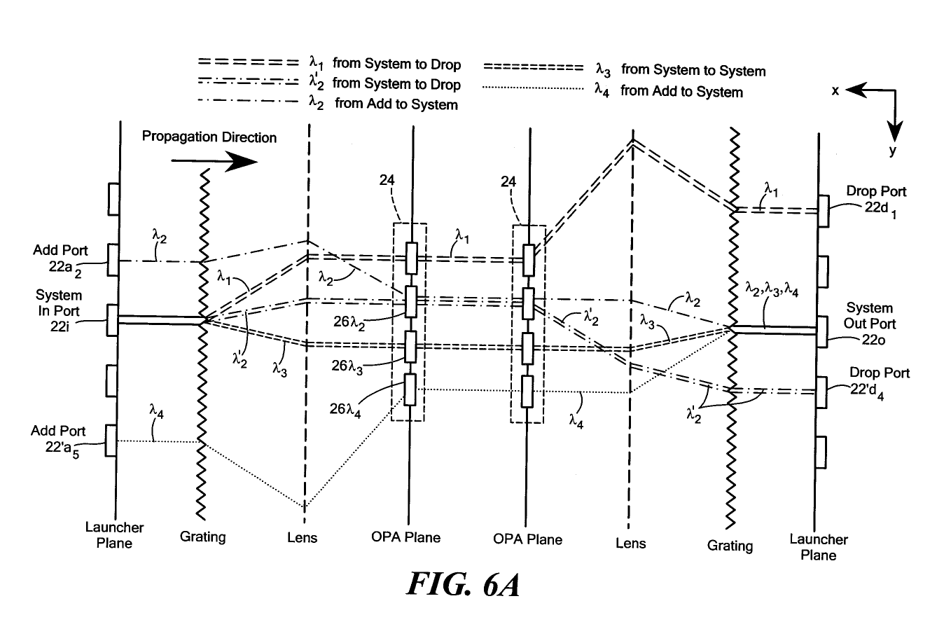

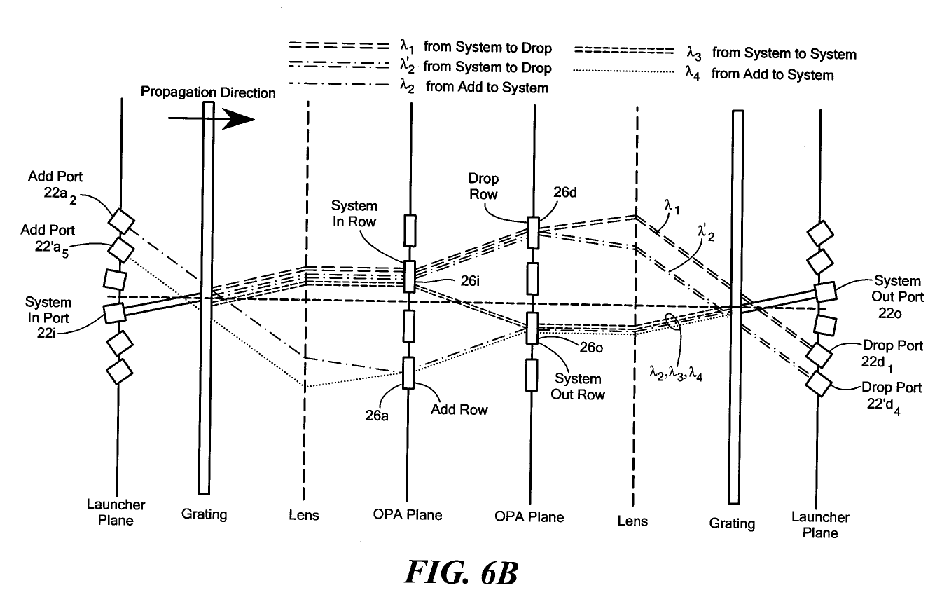

When deployed in a working DWDM system, an OADM will simultaneously perform various ones of the above operations on different optical channels: drop with an add (replacement); drop without an add (drop); add without a drop (add), and express. FIGS. 6A and 6B illustrate an example of such a combined operation. Here, optical energy of wavelength λ₂ is fed to ADD port 22a2 and optical energy of wavelength λ₄ is fed to ADD port 22′a5. Optical energy of wavelengths λ₁, λ′₂ and λ₃ are fed to IN port 22i. Note that the physical wavelengths of the two signals λ₂, λ′₂, are the same, the notation here chosen to allow the reader to follow the different signals through the system. The signals to the OPA system 24 here enable the energy of wavelength λ₂ at ADD port 22a2 to pass to OUT port 22o, the energy of wavelengths λ′₂ at IN port 22i to pass to DROP port 22′d4, the energy of wavelength λ₁ at IN port 22i to pass to DROP port 22d1, the energy of wavelength λ₃ at IN port 22i to pass to OUT port 22o, and the energy of wavelength λ₄ at ADD port 22′a5 to pass to OUT port 22o.

The DWDM signals from the upstream node consist of channels corresponding to the optical signals at IN port 22i. The channels of wavelength λ₁, λ′₂ and λ₃ are fed to IN port 22i. The optical signals at such IN port 22i at wavelength λ₃ is to be expressed while the channel of wavelength λ′₂ is to be dropped with replacement by the optical signal at the ADD port 22a2 having the wavelength λ₂ and the channel λ₁ is to be dropped without replacement. A signal at ADD port 22′a5 of wavelength λ₄, which is not among those received from the upstream node, is to be added to the output (i.e., the OUT port). The first grating disperses the light input to the device at the IN port 22i into its constituent optical channels and sends each to the appropriate aperture of the system-in row of the first OPA plane. The channels of wavelengths λ₁ and λ′₂ are steered by this first encounter with the OPA plane to the drop row of the second OPA plane, while the channel having wavelength λ₃ is steered to the system-out row. From there the channels having the wavelengths λ₁ and λ′₂ are sent to their designated DROP ports, which can be separate (as illustrated here) or the same. The channels λ₂ and λ₄ to be added enter the OADM 14 through separate ADD ports and are directed to their respective apertures in the add row of the first OPA plane, and from there to the system-out row of the second OPA plane. They could also have entered through the same ADD port. The channels λ₂, λ₃, and λ₄ from the system-out row are focused by the second lens 32 (FIG, 2) onto the grating 30, which combines them into a single beam that is sent to the downstream node via the System-OUT port.

### Operation for Optical Multicast

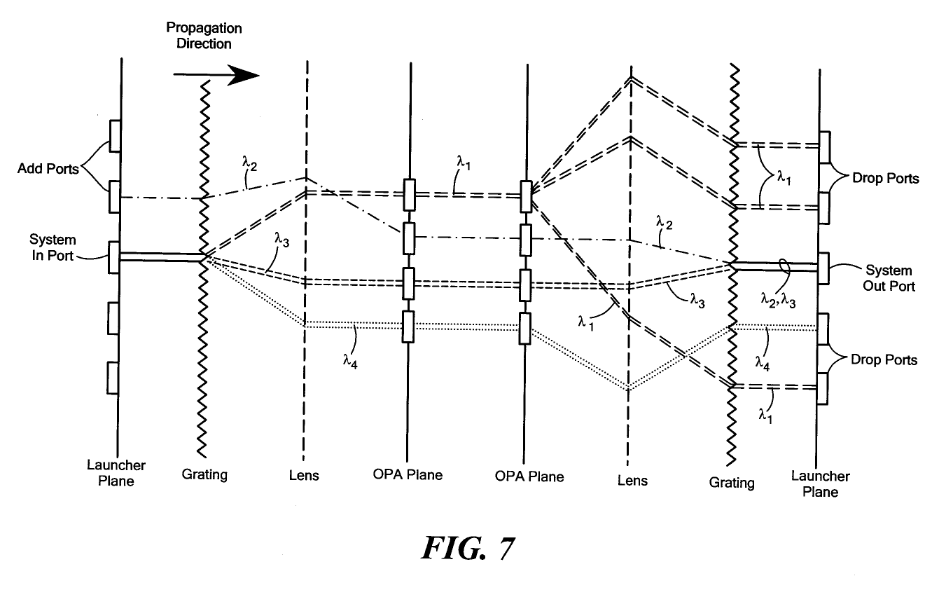

FIG. 7 illustrates how the invention can be used in an optical multicast mode without compromising its other capabilities. Channels of wavelengths λ₁, λ₃ and λ₄ are received from the upstream node and enter the device at the System-IN port. In this example λ₃ is to be expressed, λ₄ is to be dropped at a single DROP port, and λ₁ is to be multicast to three DROP ports. Simultaneously, channel λ₂, at the ADD port is to be added. All the beams are manipulated generally as discussed above except for λ₁ at the drop row of the second OPA plane. Here, instead of using the OPA electrodes to steer the beam in a single direction, a different phase profile is used. Profiles such as Dammann grating profiles are known in the art to be able to disperse one beam into several beams; other profiles may be computed by well-known means including phase-retrieval. This “fanout” profile is applied to the OPA to distribute the incident power in multiple directions. The beam directions and the power directed into each beam are precisely defined by the voltage pattern applied to the electrodes. In FIG. 7, λ₂ is sent to three DROP ports. There is no fundamental limit on the number of beams that can be generated in this way. When applied to an OADM, a typical operation is to fanout a channel being dropped at that node. Since a bidirectional embodiment of the invention has two System-OUT ports, a channel being added could be split two ways with one going to each System-OUT port. This could be used to send it to two different destinations or for path diversity in a 1+1 optical protection scheme. Because there is no limit on the number of ports, the same capability can be provided in unidirectional applications by adding one or more System-OUT ports.

### Operation for Bi-Directional Transmission

The standard design for DWDM systems is to use separate fibers for the two directions of propagation on a link connecting two nodes. This provides the best performance and simplifies engineering the transmission spans. For a system that uses one fiber for each propagation direction the preferred method for obtaining OADM functionality using this invention is to employ one device for each fiber (i.e., direction of propagation). There are, however, situations that make bidirectional propagation in a single fiber a cost-effective approach, for example, when the number of fibers is limited or the cost of leasing fibers is very high. While technically possible to counter-propagate signals at the same wavelengths, this is seldom done because it introduces serious design complications and performance impairments. The more common approaches to bidirectional operation of a fiber are to segregate into different wavebands the channels traveling in opposite directions, or to interleave wavelengths of counter-propagating optical channels. A waveband is a group of optical channels that includes all allowed wavelengths in a specified wavelength range. An example of the waveband approach would be to reserve a group of eight adjacent wavelength slots for channels traveling from east to west (“westbound”), while using a distinct group of eight adjacent wavelength slots for channels traveling from west to east (“eastbound”). In the interleaving approach every second wavelength slot is for optical channels traveling in one direction, while the alternate slots are for channels traveling in the opposite direction.

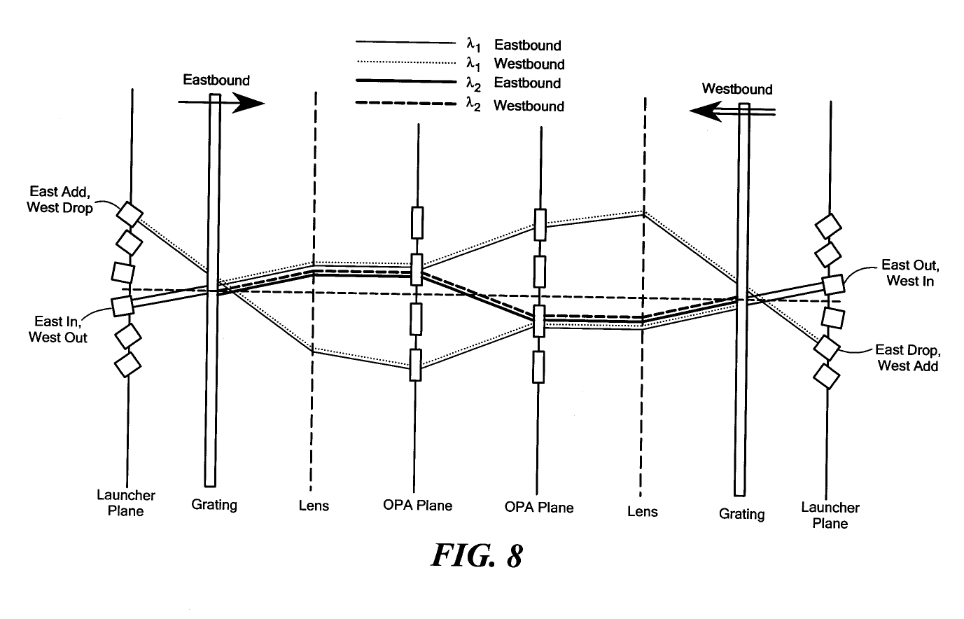

This invention is readily adapted to single-fiber, bidirectional operation because of the mirror symmetry that exists between the input and output ports, allowing each to perform both functions simultaneously. For a specific configuration of the invention, counter-propagating optical channels of the same wavelength will follow the same path through the device but in opposite directions. This behavior is illustrated in FIG. 8 where the eastbound channels are shown as solid light or heavy lines and the westbound channels as dashed or dotted lines. Two wavelengths are illustrated, one as the light (solid or dotted) lines and one as the heavy (solid or dashed) lines. FIG. 8 also indicates a constraint on single-fiber, bidirectional systems that counter-propagate the same wavelengths: The OADM must perform the same function on a given wavelength for both directions of propagation. Thus if a given wavelength is expressed in one direction, it must be expressed in the opposite direction. A wavelength that is dropped in one direction must be dropped for the same wavelength propagating in the opposite direction. It should be noted that the full drop and replace operation need not be performed in either direction. A wavelength can be dropped without replacement or added where there was none in the system. Another constraint apparent from FIG. 8 is that the ADD port for a channel traveling in one direction must be the DROP port for the same channel traveling in the opposite direction. Thus, while the invention remains fully flexible with respect to which port a given wavelength can be assigned, an assignment for one direction of propagation also assigns the opposite direction to the same set of ports. Separating the input and output on the same client interface requires the use of an optical circulator, which are always required in bidirectional systems that use the same wavelengths in both directions.

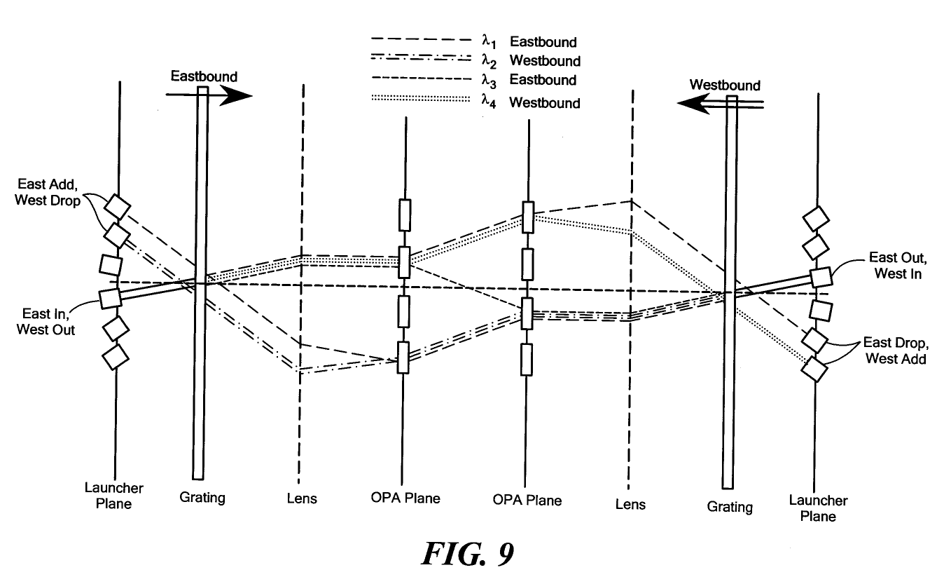

FIG. 9 is an illustration of the invention used in a single-fiber, bidirectional system with different wavelengths reserved for each direction. In this example, the eastbound wavelengths λ₁ and λ₃ enter the device from the transport fiber connecting the node to its neighbor lying to the west, and the westbound wavelength λ₂ enters the device from the transport fiber connecting it to the node lying to the east. The eastbound wavelength λ₁ is dropped with replacement while the eastbound wavelength λ₃ is expressed through the node. For the westbound traffic, the wavelength λ₂ is dropped without replacement and the wavelength λ₄ is added. Because the invention is inherently bidirectional, the same embodiment can accommodate unidirectional or bidirectional traffic with the same functionality and flexibility if each wavelength is only used in one direction at any given time. The operation of the invention is not affected by whether the bidirectional traffic is in wavebands or interleaved.

### Operation for Protection Switching

Service providers require that telecommunications systems have very high availability, typically 99.999% or higher. This objective is achieved through redundant deployment of high reliability equipment. An OPA-based OADM will have inherently high reliability because it has no moving parts, is entirely electronic, and is fabricated using mature semiconductor and liquid crystal display techniques. In addition, it is possible to install and configure such devices in ways that provide protection against a failure of the OADM itself, the transceivers connected to it, or the transmission link connecting OADMs in the network.

### OADM Failure

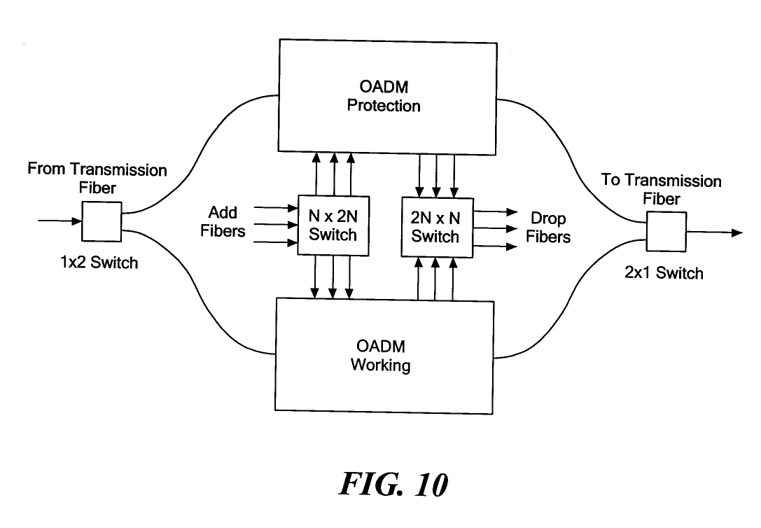

The invention is readily adapted to the standard method of using a redundant unit to provide backup in case of OADM failure. FIG. 10 illustrates one such adaptation using a working unit and a protection unit. The input to the node from the transmission fiber initially passes through a 1'32 switch. Normally it is set to direct the multiplexed optical channels to the working or primary OADM. The adds and drops pass through N×2N switches, where the number of adds or drops at this node is less than N. These switches connect all N adds as a block to either the primary or backup unit. Similarly, the origin of the N drops is selected to be either the primary or the backup unit. The outputs of the two OADMs are connected to a 2×1 switch that is set to connect the active unit to the transmission fiber. This approach to redundancy duplicates only the OADM being protected. The transceivers for the adds and drops are not duplicated but switched to the proper OADM. Low cost, high-reliability switches are used for this purpose.

### Transceiver Failure

Protecting against transceiver failure is readily accomplished by providing spare units connected to add and drop fibers at each node. If a working unit fails a spare is switched in to replace it. Because of the any-to-any connectivity of a dynamic OADM, the spare can be at a different wavelength as long as this wavelength is not already being used for another connection. Transceiver and OADM protection can be accomplished simultaneously by having the spare units attached to spare add and drop fibers in FIG. 10.

### Span Failure

Intelligent nodes must also protect the system against failures in the transmission spans of the network. These are usually due to fiber breaks but can also be caused by manual misconnection of fiber jumpers at nodes or other maintenance access points for the network. Various embodiments of the invention integrate span protection into their operation. FIG. 11 is an example of a DWDM ring in normal operation. For clarity, a two-fiber, two-node ring is discussed, but the extension to linear, ring, and mesh systems with more than two fibers and more than two nodes is obvious. The system in FIG. 11 has two fibers: a working fiber that operates in the counter-clockwise direction and a protection fiber that operates in the clockwise direction. In normal operation only the working fiber carries traffic between the nodes. Each node has client interfaces that are used to add and drop wavelengths.

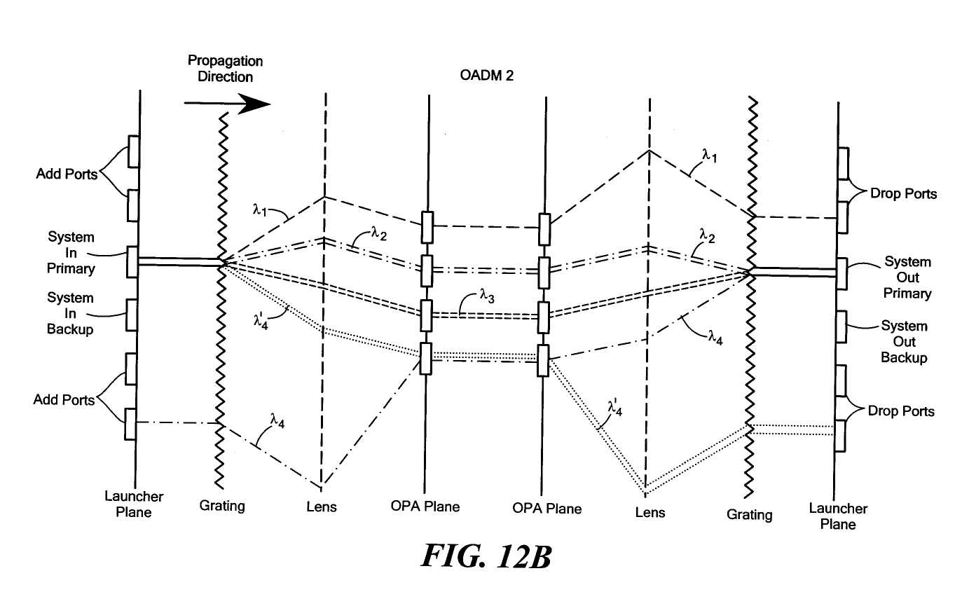

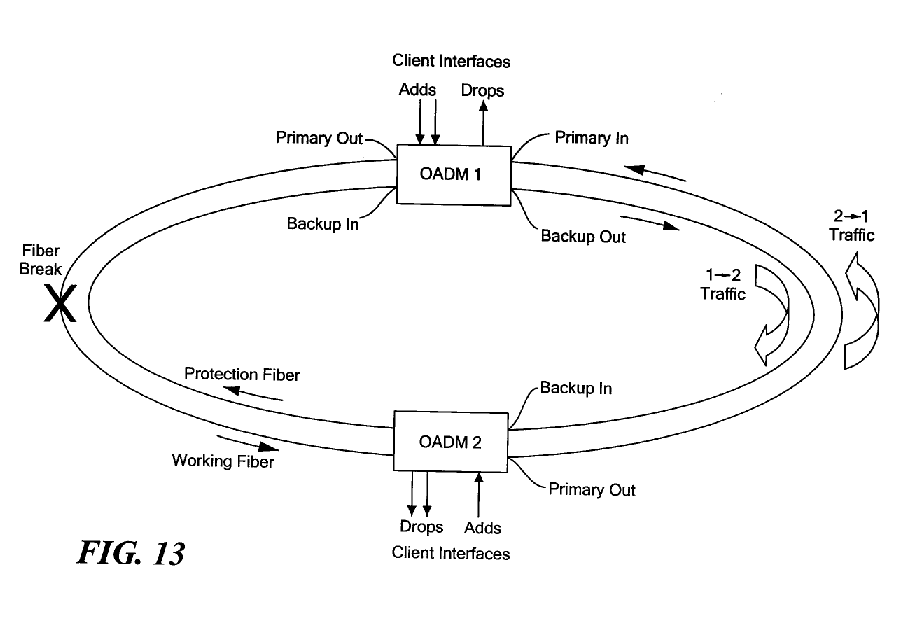

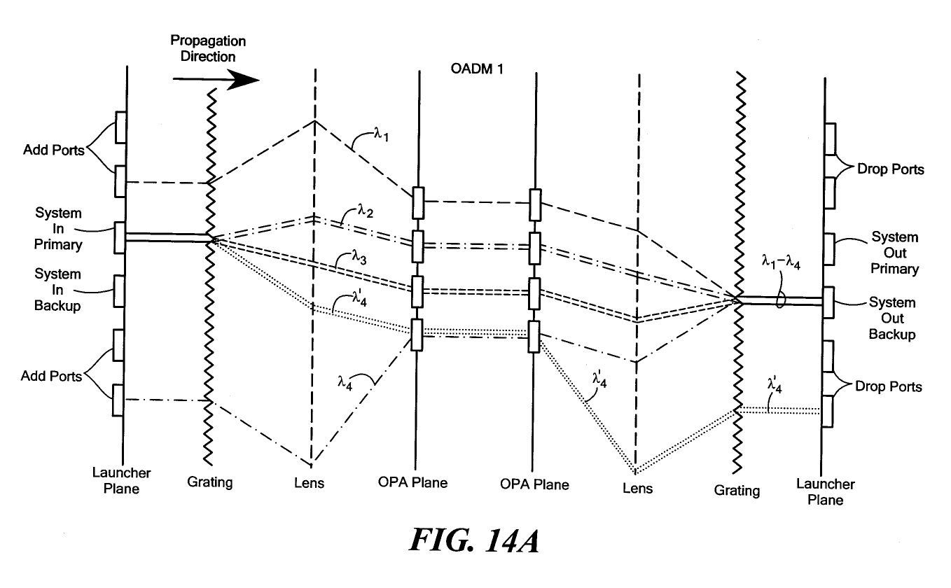

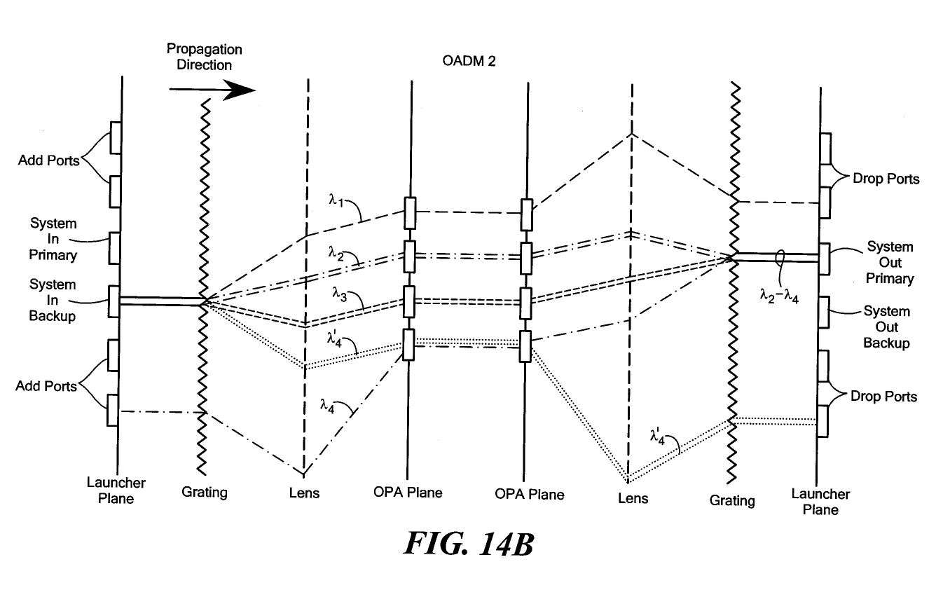

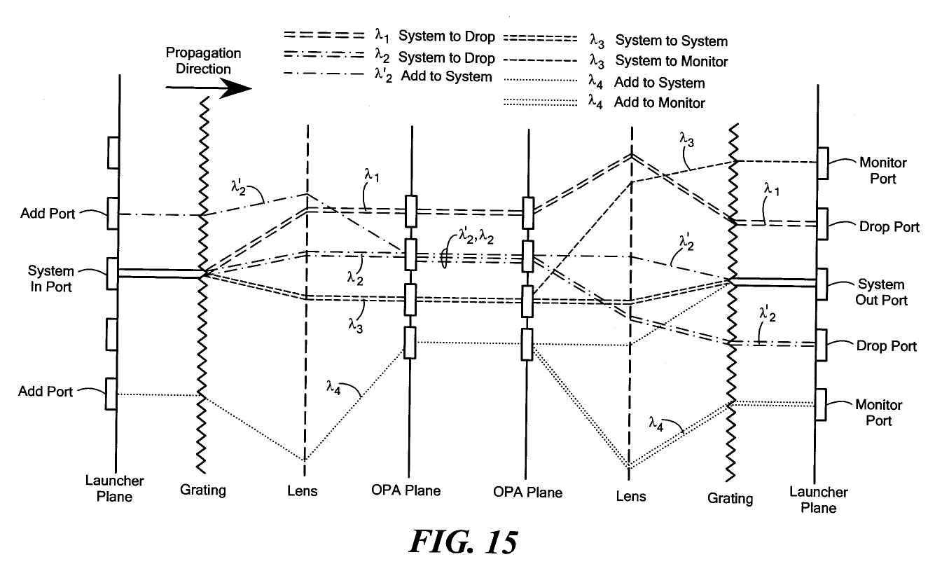

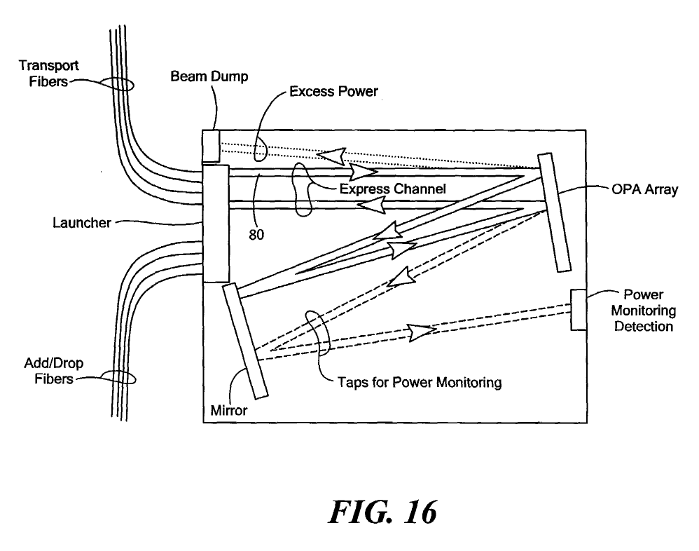

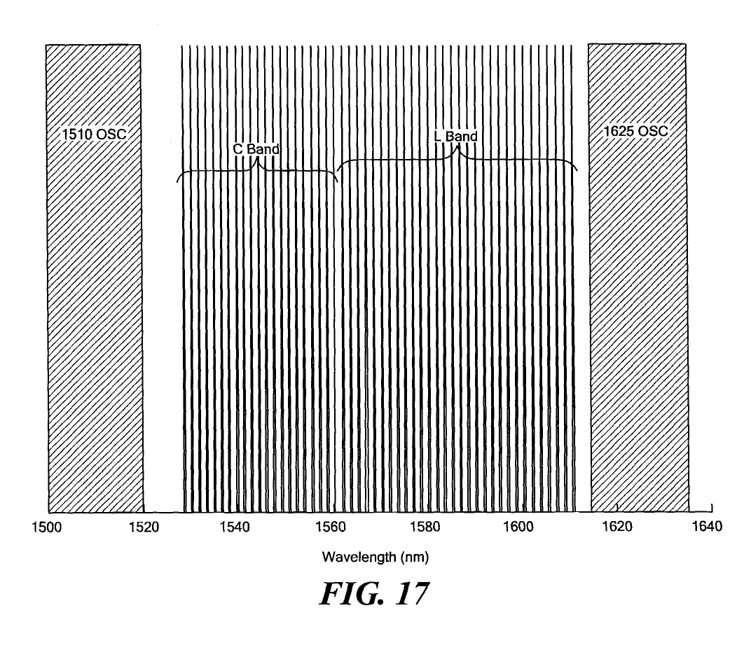

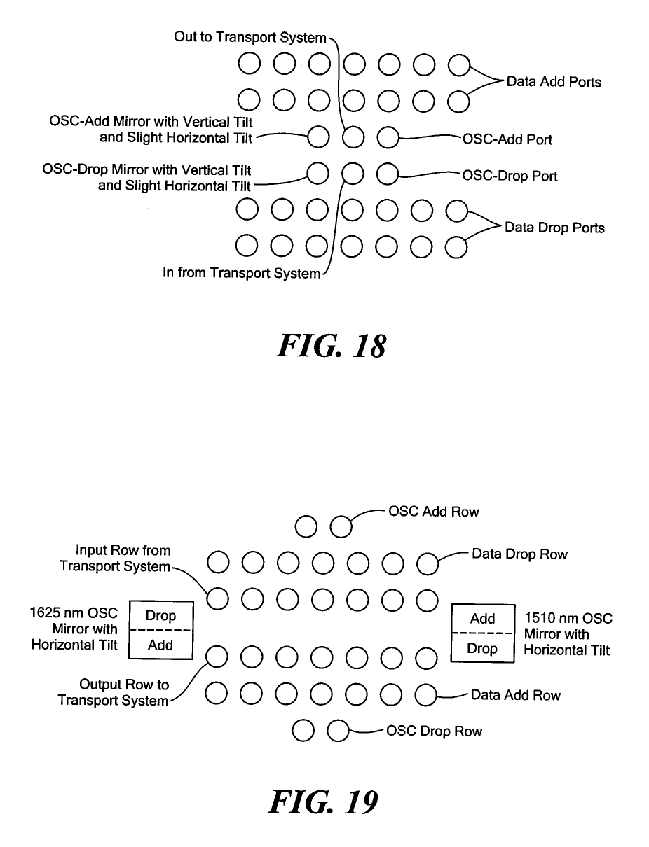

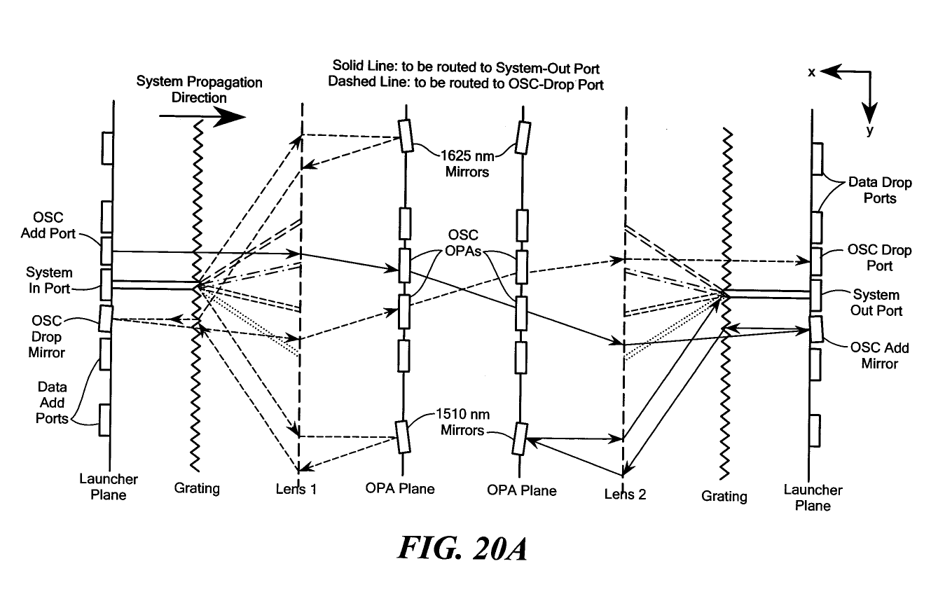

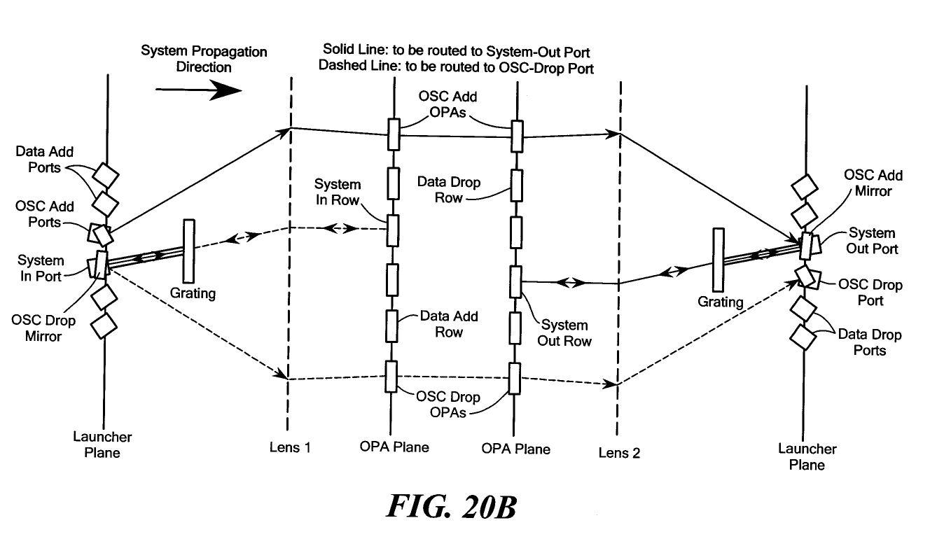

FIGS. 12A and 12B illustrate example configurations for the OPA-based OADM 1 and OADM 2, respectively. In this example both OADMs perform a drop and replace of the λ₄ channel, while OADM 1 adds the λ₁ channel and OADM 2 drops the λ₁ channel without replacement. Both OADMs have λ₂ and λ₃ express channels only to illustrate their management. In actuality, there can be no express channels in a system with fewer than three nodes, and these express channels are shown only to assist in understanding the operation of the invention in systems with more than two nodes. A comparison of FIGS. 6A and FIGS. 12A and 12B show that adding the capability to protect transmission spans requires only the addition of one input and one output port to other embodiments of the invention. The System-In Primary and System-Out Primary Ports are connected to the working fiber, and the System-In Backup and System-Out Backup Ports are connected to the protection fiber.

FIG. 13 illustrates the operation of the same ring when a fiber break has occurred. Traffic going from node I to node 2 can no longer use the working fiber and has been switched to the protection fiber on the opposite side of the ring. FIG. 13 shows that this requires that traffic that would have been on the System-Out Primary Port of OADM 1 must be switched to the System-Out Backup, and that OADM 2 must be reconfigured such that traffic that would have been received on the System-In Primary Port is now received on the System-In Backup Port. An additional requirement is that the wavelengths added and dropped at each node must not be altered.

FIGS. 14A and 14B indicate the new configurations of OADM 1 and OADM 2, respectively. For OADM 1 the input to the device is on the same port as in normal operation, but all the output channels are directed to the System-Out Backup Port, which puts them on the undamaged fiber. The channels being added and dropped enter and exit the device on the same ports as before, so no reconfiguration of the client interfaces is required. FIG. 14B shows that for OADM 2 the input from the protection fiber enters the device at the System-In Backup Port and the output exits through the System-Out Primary, which is connected to the undamaged span of the working fiber. As with OADM 1, the configuration of the adds and drops is not disturbed.

This embodiment of the invention provides transmission span protection without the need for external switches. The client interfaces are not affected by a protection switch event, and the same wavelengths can be added and dropped on the same ports as before. No backup transceivers are required for span protection using this approach. The modification of the invention needed to provide this function is minor and this embodiment can be combined with other embodiments in a single device to perform multiple functions.

### Operation for Optical Performance Monitoring

Service providers need to ensure that the quality-of-service guarantees they give customers are being met. Services are increasingly being carried over optical networks and these networks are becoming more optically transparent. This means that optical channels travel farther and traverse more network nodes before being converted to electrical signals. Since most approaches to performance monitoring require analyzing signals in the electrical domain, it is becoming increasingly difficult for service providers to assess the state of their signals between optical path endpoints and to localize faults when they occur. This has led to a need for analyzing the health of optical signals, typically by tapping off a small fraction of the signal and analyzing it in the optical or electrical domain. The analysis can be as simple as detecting loss of signal or as complex as optical signal-to-noise ratio measurement, bit error-rate testing, or Q-factor determination. To date, most optical performance monitoring systems are external to the switching and transmission equipment, being add-on boxes that must be connected to the system by optical taps. This increases both the capital and operations costs for the service providers, as well as taking up valuable space and requiring additional training for technicians.

The ability of OPAs to split an optical beam into multiple beams and control both the power and direction of each beam independently was discussed in the context of multicasting described above. This capability can be exploited in an embodiment of the invention that provides integrated optical performance monitoring by adding one or more Monitor Ports to the output ports. The operation of such a device is illustrated in FIG. 15, which shows how a small fraction of the energy in specified optical channels can be split off, i.e. “tapped”, and directed to Monitor Ports while the majority of the power continues in the required direction. The Monitor Ports can be normal Drop Ports that use fibers to transport the tapped signal to a remote analyzer, or they can be photodetectors that convert the optical signal to an electrical signal for processing by associated electronics. Any channel can be monitored and the specific ones to be monitored at any time can be specified by electronic instructions to the OPA controller. While FIG. 15 shows the tap being generated by the second OPA plane, it could also be generated at the first OPA plane.

The ability of the OPAs to vary the fraction of power tapped enables them to adapt the performance monitoring operation to a wide range of conditions. For example, different types of monitoring analysis require different amounts of optical power, and different channels will have different power levels at the node. Since any tap is deleterious to the signal, the OPA can direct to the Monitor Ports the minimum power necessary for the measurements being made. Not all channels need to be monitored. In general, optical channels being dropped at the node do not need monitoring if they are to be converted to an electrical signal because receivers provide signal quality analysis. Dropped channels that remain in the optical domain and are inserted into other systems without electronic processing may require monitoring, together with express channels and channels being added. Monitoring added channels is useful for ensuring that they are being inserted into the system with adequate power and signal quality.

The decision on how many Monitor Ports to include in a device requires a cost-performance trade-off analysis. Providing one port for every optical channel in the system will usually be unnecessary and costly. Having only one port requires that the channels to be monitored are cycled through that single port, and may result in unacceptably long intervals between the analysis of any given channel. If the monitoring apparatus is connected to the device by fiber, then there need be no distinction between Monitor Ports and Drop Ports. This allows any port to be assigned to either function depending on local circumstances.

### Operation for Channel Equalization

A very important consideration in the operation of optical networks with optical amplifiers is maintaining a power balance between the multiplicity of optical channels in the system. The gain of optical amplifiers saturates because there is a limit on the amount of power they can deliver to the system channels. If some channels have significantly more power than others in a DWDM system, they will draw more power from the amplifiers at the expense of the weaker channels, leading to degraded signal-to-noise ratio in the latter. The reason for the initial disparity in channel powers is that at any point in the system there will be channels that have originated from different nodes and traveled a different distance to reach that point. Ideally, one should adjust the channel powers such that each has the same signal-to-noise ratio at its respective receiver (pre-emphasis). Because this is impractical in current networks, the simpler approach of adjusting each channel to have the same power before entering an optical amplifier (equalization) is used. This is typically done by reducing all other channels to the power of the weakest one. Equalization requires a means to measure the power of each channel and a means to independently attenuate the power of each channel to the desired value. Typically this is done using an external apparatus made for this purpose that must be inserted into the optical system before every or some fraction of the optical amplifiers.

The ability of OPAs to split an optical beam into multiple beams and control both the power and direction of each beam independently allows the equalization operation to be integrated into an OPA-based OADM. Integrating this important function into the OADM lowers service provider capital and operations costs, improves space utilization, and reduces technician training. FIG. 16 illustrates an embodiment of the invention using a reflective design that provides the equalization functionality. This is an example of one configuration of the invention to perform this function; others embodiments, including transmissive designs, can also perform this function. In FIG. 16 only an express channel is shown; the extension to add and drop channels is straightforward. In FIG. 16 the device shown in FIG. 2 has been simplified to elucidate more clearly the operation here described. The beam 80 enters the OADM and is directed (via the grating, not shown) to the first OPA (or other beam steering system embodiment). The latter splits off the fraction of the beam needed to reduce it to the specified power and steers that fraction to a beam dump for absorption. If the objective is power equalization, the fraction dumped will be that needed to lower the power of this channel to that of the weakest channel at this point in the system. The continuing beam reflects off the mirror and impinges on the second OPA, which directs a small fraction of the beam to a power monitoring detector or performance monitoring port to determine the amount of attenuation necessary. This configuration allows the power in this channel to be controlled using a feedback loop before returning it to the transport fiber. Although FIG. 16 shows the first OPA attenuating the beam and the second tapping it for monitoring purposes, these roles can be reversed or either OPA can be used to perform both functions.

### Management of the Optical Channels

The optical service channel (OSC) is intended to provide optical links between network elements specifically for telemetry, fault and performance monitoring, and management and control. The OSC is carried on the same fiber as the data channels but at a different wavelength. In order to provide communications between all network elements, the OSC is terminated and retransmitted at every network element, even those at which the bearer traffic remains in the optical domain. The OSC bandwidth is low compared to the data links, being typically 1.5-2 Mb/s although some manufacturers provide rates up to 155 Mb/s. ITU-T Recommendation G.692, Optical Interfaces for Multichannel Systems with Optical Amplifiers, specifies that the OSC can be at 1510±10 nm or 1480±10 nm. In addition to these wavelengths, many manufacturers have placed the OSC at 1625 nm. The large uncertainty in the wavelength of the OSC together with its position outside the C and L Bands make it impractical to manage the OSC in the same, high-resolution manner as the data channels. This difficulty is illustrated graphically in FIG. 17, which shows the C and L Bands with data channels spaced at, for example, 200 GHz on the ITU-T grid together with the allowed wavelength ranges for the 1510-nm and 1625-nm OSC's. A grating that provides sufficient dispersion to separate the data channels has more dispersion than is needed to process the OSC with its loose wavelength tolerance. To overcome this problem, the invention uses the grating to separate the OSC from the data channels but then cancels the dispersive effect of the grating so that the OSC can be treated in a wavelength-independent way.

The preferred embodiment of the invention for practical management of the OSC uses extensions to the basic design that do not limit any other application of the invention or add significantly to its cost. It is assumed that each transport fiber contains one OSC. If multiple OSC's are carried on each fiber, they can be managed using obvious modifications to the single OSC design of the invention. FIG. 18 shows the launcher array plane for these extensions. In addition to the Data Add, Data Drop, System-In, and System-Out Ports, an OSC-Add Port and an OSC-Drop Port are added. OSC-Add and -Drop Mirrors are also added to the launcher plane.

FIG. 19 illustrates the OPA plane with the adaptations required to manage the OSC. As in other embodiments of the invention, it has OPA apertures arrayed in rows and colunms, where each of the four rows corresponds to a function and each column corresponds to a data wavelength in the system. In addition there are mirrors located to left and right of the OPA array. The two mirrors to the left of the array are for the 1625-nm OSC while the two mirrors to the right of the array are for the 1510-nm OSC. The mirrors are positioned horizontally such that their centers are at the positions to which the grating will diffract optical energy of 1625 nm and 1510 nm, respectively. The horizontal widths of the mirrors correspond to slightly more than the spectral tolerance (±10 nm) for the OSC's. For each OSC wavelength there are two mirrors: an upper one on which impinges the incoming OSC from the upstream node, and a lower one which impinges the outgoing OSC destined for the downstream node. Because of the input/output symmetry of the invention, a single mirror of sufficient height can also be used for both input and output functions. Also added to the OPA plane are two additional OPA apertures located above the data drop row that are used for adding the OSC, and two OPA apertures below the data add row for OSC drop purposes. The location of the OPA apertures in FIG. 19 is for illustrative purposes only, and while they offer certain advantages regarding the implementation of the invention, the invention applies to other configurations of OPA aperture placement.

FIGS. 20A and 20B are top- and side-view conceptual diagrams illustrating the operation of the invention for adding and dropping the OSC. This embodiment of the invention simultaneously retains the capability to add and drop data channels, although this is not illustrated in FIG. 20A and 20B for reasons of clarity. In FIG. 20A all optical channels from the upstream node enter the invention through the System-In Port at which they are collimated. They next impinge on a diffraction grating that disperses each channel according to its wavelength. Because the OSC wavelengths are beyond the range of data wavelengths, the OSC channel will be diffracted outside the range of data channels and impinge on either the upper 1625-nm mirror or the upper 1510-nm mirror indicated. The mirrors are wide enough to intercept any wavelength within the standard tolerances for the OSC. The mirrors are used to reverse the path of the OSC, sending it back through the grating where the dispersion is canceled. The mirrors have a slight horizontal tilt so that the returning OSC optical energy misses the System-In Port and instead strikes the OSC-Drop Mirror next to it. FIG. 20A shows the path for both a 1625-nm and 1510-nm OSC. Because the second grating pass has canceled the dispersion, the OSC will always strike the OSC-Drop Mirror at the same position and angle regardless of its wavelength. The OSC Drop mirror imparts a downward tilt that is sufficient for the reflected beam to pass below the grating before impinging on Lens 1 (FIG. 20B). It should be noted that if the overall OADM layout is such that an inconveniently large angle is required to enable the OSC beam to miss the grating, a second mirror may be placed just below the grating to adjust the propagation direction of the OSC signals to the desired value. The lens directs the OSC beam to the first OSC-Drop OPA aperture, which then sends it on to the second OSC-Drop OPA aperture. The OPAs are not needed to provide large-angle steering for the beam as with the data channels since the OSC will always be dropped. As with the data channels, they provide fine alignment and focusing to optimize the coupling between input and output ports. After leaving the second OSC-Drop OPA the OSC beam is directed to the OSC-Drop Port by Lens 2, again missing the grating.

The OSC-Add process is the reverse of the drop process. The beam enters the invention through the OSC-Add Port, misses the grating, and is directed to the first OSC-Add OPA by Lens 1. From there it passes to the second OSC-Add OPA and then to Lens 2, from which it passes above the grating and strikes the OSC-Add Mirror. The latter reflects the beam to the grating, which disperses it, and then to Lens 2 so that it strikes the lower 1625-nm or 1510-nm mirror. This mirror sends it back through the lens and grating after introducing a tilt that shift the point of impingement from the OSC-Add Mirror to the System-Out Port, where it exits the invention together with the data channels. As with the data channels, two OPA apertures are required for each beam in order to provide the independent control of angle and position that is needed to optimize coupling to single mode fiber. As seen in FIG. 20A, the OSC-Add and -Drop Mirrors may use a small horizontal tilt to facilitate the direction of the beam from the first to the second OSC-OPA aperture. In addition, vertically angling the OSC-Add and -Drop Ports helps accommodate the vertical deflections needed for the beam to pass above or below the grating where needed.

### Compensation for Polarization Dependent Loss

Polarization-dependent loss (PDL) must be kept to a minimum for equipment in optical networks because it accumulates along optical paths and can result in signal fading because polarization states in fiber drift in time. The polarization dependence of the nematic liquid crystals used in the OPAs can be canceled in the transmissive mode by having the optical energy traverse two OPAs oriented at 90 degrees to each other with regard to the extraordinary axis of their liquid crystals. The article by Love, referenced above, describes how the polarization-dependence of the liquid crystals can be compensated in the reflective geometry by double passing the optical energy through the liquid crystal cell using a mirror with a quarter wave plate between the cell and the mirror. This causes the optical energy to traverse the cell first with one polarization state and then with a state rotated by 90 degrees.

The second major source of PDL is the grating. Even Echelle diffraction gratings have some residual polarization dependence. This and PDL from other components of the device can be compensated to first order by placing a polarization rotator at the central plane of the device, which corresponds to the folding mirror in the folded design. If the folded design is used, the method of Love described in the above-referenced article can be applied by putting a quarter wave plate in front of or attached to the folding mirror in FIG. 2. This causes the optical energy to propagate back through the device with its polarization state rotated by 90 degrees. This should cancel polarization sensitivity in detail because the two polarization states will have experienced approximately the same loss by traversing the same components. For the transmissive design a half wave plate is placed at this central plane. This causes the optical energy to traverse the second half of the device with its polarization state rotated by 90 degrees. However, this can only compensate for generic polarization sensitivity since the two polarization states will traverse different instances of the same components.

Because OPAs can operate as electronic lenses, the assembly tolerances of devices based upon them can be significantly relaxed. The aiming accuracy for the combination of launcher, grating, and lens need only be sufficient for the beams to impinge on the OPA plane within the aperture of the OPAs. The OPAs then compensate for misalignments and steer the beams accurately to their destination ports. Because OPAs focus as well as steer beams, they can compensate for focusing errors in the launchers and lenses. Another capability is the ability of an OPA device to automatically align itself by learning the corrections needed for optimum alignment. This can be done as a final step in assembly, periodically as scheduled maintenance, or in-service through dithering and feedback loops. Accordingly, the various embodiments of the invention can be assembled with mechanical tolerances and then operate with an alignment based on optical tolerances.

A number of embodiments of the invention have been described. Nevertheless, it will be understood that various modifications may be made without departing from the spirit and scope of the invention. Accordingly, other embodiments are within the scope of the following claims.

What is claimed is:

1. An add/drop unit comprising:
an input port;
an output port;
an add port;
a drop port;
an electronically controllable beam steerer for receiving optical energy at the input port and optical energy at the add port for selectively: directing the optical energy at the input port to the output node or to the drop port; and for directing the optical energy from the add port to the output port.

2. The system recited in claim 1 wherein the beam steerer comprises an optical phased array.

3. The system recited in claim 1 wherein the wavelength multiplexer/demultiplexer uses an Echelle grating.

4. An optical communication system, comprising:
an add/drop unit comprising:
an input port for receiving optical energy having a plurality of different wavelengths from a source node;
an output port for coupling to a destination node;
an add port for receiving optical energy having the plurality of different wavelengths for transmission to destination nodes;
a drop port;
an electronically controllable beam steerer for receiving the optical energy having the plurality of different wavelengths at the input port and the optical energy having the plurality of different wavelengths from the add port for selectively: directing the optical energy having the plurality of different wavelengths at the input port to the output port or to the drop port; and directing the optical energy having the plurality of different wavelengths from the add port to the output port.

5. The system recited in claim 4 wherein the wavelength demultiplexer and multiplexer use an Echelle grating.

6. The system recited in claim 4 wherein the beam steerer comprises an optical phased array.

7. An optical communication system, comprising:
an add/drop unit comprising:
a network input port for coupling to a source node;
a network output port for coupling to destination node; an add port for transmitting optical channels to additional network nodes;
a drop port for receiving optical channels from additional network nodes;
a wavelength multiplexer/demultiplexer for combining/separating the optical channels;
an electronically controllable beam steerer for receiving optical energy at the network input port and optical energy from the add port for selectively: directing the optical energy at the network input port to the network output port or to the drop port; and directing the optical energy from the add port to the network output port.

8. The system recited in claim 7 wherein the wavelength demultiplexer and multiplexer use an Echelle grating.

9. The system recited in claim 7 wherein the beam steerer comprises an optical phased array.

10. An optical communication system, comprising:
a launcher having a plurality of ports, each one of the ports being adapted to carry information in a plurality of optical wavelengths, a first set of the ports being network input type ports, a second set of the ports being network output type ports, a third set of the ports being channel add type ports and a fourth set of the ports being channel drop type ports;
an optical system comprising:
an electronically controllable beam steering system, such system having a plurality of sections, each the sections being associated with a corresponding to one of the launcher port types, each one of the sections having a plurality of beam steerers, each one of the beam steerers corresponding to one of the optical wavelengths used in the optical communications system; and
an optical system for directing optical energy at each one of the launcher ports to the associated one of the plurality of sections of the beam steering system with each one of the plurality of the optical wavelengths of such directed optical energy being directed to a corresponding one of the one of the beam steerers associated with such plurality of optical wavelengths;
wherein the associated one of the plurality of sections of the beam steering system receiving such directed energy re-directs such received optical energy to another one of the sections of the beam steering system selectively in accordance with one of a plurality of system functions and
wherein each one of the plurality of optical wavelengths of such re-directed optical energy is re-directed to the to the corresponding one of the beam steerers of said another one of the sections of the beam steering system associated with such one of the plurality of optical wavelengths; and
wherein said another one of the sections of the beam steering system re-directs to corresponding one of the launcher port types.

11. The system recited in claim 10 wherein the wavelength demultiplexer and multiplexer use an Echelle grating.

12. An add/drop unit comprising:
a network input port;
a network output port;
a plurality of add ports;
a plurality of drop ports;
a wavelength multiplexer/demultiplexer coupled to the network input port, the network output port, the plurality of add ports and the plurality of drop ports for combining/separating wavelengths at the network input port, the network output port, the plurality of add ports and the plurality of drop ports;
an electronically controllable beam steerer, coupled to the wavelength multiplexer/demultiplexer, for receiving optical energy at the network input port and optical energy at the add ports for selectively: directing the optical energy at the network input port to the network output port or to the drop ports on a per optical channel basis; and for directing the optical energy from the add ports to the network output port.

13. The system recited in claim 12 wherein the electronically controllable beam steerer comprises an optical phased array.

14. The system recited in claim 12 wherein the wavelength multiplexer/demultiplexer uses an Echelle grating.

15. An optical communication system having a plurality of network nodes, one of such node being an add/drop node comprising:
a network input port for receiving optical energy having a plurality of different wavelengths from a source node;
a network output port for coupling to a destination node;
a plurality of add ports for receiving optical energy of different wavelengths for transmission to other ones of the network nodes;
a plurality of drop ports for delivering optical energy of different wavelengths received from still other ones of the network nodes;
a wavelength demultiplexer for separating the plurality of different wavelengths received from the network input port for delivery to an electronically controlled beam steerer;
a wavelength multiplexer for combining the plurality of different wavelengths received from the electronically controlled beam steerer for delivery to the network output port;
wherein the electronically controllable beam steerer receives the optical energy having the plurality of different wavelengths at the network input port and the optical energy having the plurality of different wavelengths from the add ports for selectively: directing the optical energy having the plurality of different wavelengths at the network input port to the network output port or to the drop ports; and directing the optical energy having the plurality of different wavelengths from the add ports to the network output port.

16. The system recited in claim 15 wherein the wavelength demultiplexer and multiplexer use an Echelle grating.

17. The system recited in claim 15 wherein the beam steerer comprises an optical phased array.

18. An optical communication system, comprising:
an add/drop node comprising:
a network input port for coupling to a source node;
a network output port for coupling to a destination node; a plurality of add ports for transmitting optical channels to additional network nodes;
plurality of drop nodes for receiving optical channels from additional network nodes;
a wavelength multiplexer/demultiplexer for combining/separating the optical channels;
an electronically controllable beam steerer for receiving optical energy at the network input port and optical energy from the add ports for selectively: directing the optical energy at the network input port to the network output port or to the drop ports; and directing the optical energy from the add ports to the network output port.

19. The system recited in claim 18 wherein the wavelength demultiplexer and multiplexer use an Echelle grating.

20. The system recited in claim 18 wherein the beam steerer comprises an optical phased array.

21. An optical communication system, comprising:
a network input port for receiving optical energy having a plurality of different wavelengths from another node in a network;
a network output port for coupling to a destination node in the network;
a plurality of add ports for receiving optical energy having the plurality of different wavelengths from a local source for transmission to other nodes in the network; and a plurality of drop nodes for receiving optical energy from other nodes in the network for local processing;
a wavelength demultiplexer for separating the plurality of wavelengths received by the network input port;
an electronically controllable beam steerer for process the plurality of wavelengths received by the network input port individually;
a wavelength multiplexer for combining the plurality of wavelengths received from the electronically controlled beam steerer for delivering to the network output port for transmission to other nodes in the network.

22. The optical communication system recited in claim 21 wherein the electronically controllable beam steerer receives the optical energy having the plurality of different wavelengths at the network input port and the optical energy having the plurality of different wavelengths from a plurality of the add ports for selectively: directing the optical energy having the plurality of different wavelengths at the network input port to the network output port or to the drop ports; and directing the optical energy having the plurality of different wavelengths from the add ports to the network output port.

23. The optical communication system recited in claim 22 wherein the beam steerer comprises optical phased array elements.
